(19) United States
(12) Patent Application Publication
(10) Pub. No.: US 2006/0242940 A1
(43) Pub. Date: Nov. 2, 2006

(54) ROTARY ENGINE USING TRADITIONAL PISTONS OF FLEXIBLE MOTION

(76) Inventor: Shirwan Al Bahdaini, Geneva (SZ)

Correspondence Address: JEFFREY FURR, 253 N. MAIN STREET, JOHNSTOWN, OH, 43031, US

(21) Appl. No.: 11/164,770

(22) Filed: Dec. 5, 2005

Related U.S. Application Data
(63) Continuation-in-part of application No. 09/582,634, filed on Sep. 13, 2000.

(51) Int. Cl. F02C 5/00

(52) U.S. Cl. 60/39.44

(57) ABSTRACT

A combustion engine that increases fuel power by using kinetics energies from the motions of elements inside this engine during fuel combustion mission to act effectively and positively as additional power to increase engine output by implementing centrifugal and aerodynamic physical concepts. This engine has a network for external managing control using traditional accessories and a design for internal network to serve the mechanical activities enabling the engine to provide its many features. The engine demonstrates a composite performance of a piston engine, a rotary engine and a turbine engine all in one engine unit. It features reduction of fuel consumption according to power/weight ratio, option of independent control for pistons or engine parts by conducting them as automatic performance, and treatment of exhaust gases in engine by a built-in design.

This application is a Continuation-in-Part Application of application Ser. No. 09/582,634 filed Sep. 13, 2000.

### BACKGROUND OF INVENTION

1. Field of Invention

The present invention relates to an engine, and more particularly, a rotary engine using traditional pistons of flexible motion.

2. Description of Prior Art

It has been more than one hundred years since the invention of Otto petrol internal combustion engine appeared, which is still used now to supply automotive powers. The fast progress in the world, the economic problems, the lack of energy, and the increase of pollution on earth make it necessary to develop a more advanced automotive system—a compact engine that could convince environmentalist organisations and consumers who are ambitious to use a system depending on improved techniques suited to the computer age, and in the mean time providing methods to get use of those huge industries of regular weapons products, to be for civil efforts. Thus such advanced system in specifications, economic and has best utilisation for fuel energy with less pollution effect, is required to provide a promoting solution for the near future problems, (referring to 1998 Kyoto summit about industrial pollution).

A new environment-friendly generation of clever combustion engines is about to appear. It depends on solidarity of many scientific concepts, some defining natural events and some having been used in atmospheric flying missions and in the space away from earth's gravity, all inside this compact automotive discipline.

It was the inventor's dream ten years ago to succeed at the same time that an industrial community, such as when the United States Government had appealed in 1995 to find a more advanced automotive system for the future. This powerful system is flexible in operation and harmonic in performance, an automotive engine which could become as close to Man's orders as to a live object, rather than just a machine.

It is time to reconsider the use of the potential energy of Petrol fuel in producing automotive energy for power engine equipment. It could be used in a way that wouldimprove the energy of fuel combustion in engines to achieve its maximum useful potential advantage in producing automotive power. This could be done by employing some natural universe concepts inside the engine discipline, using advanced techniques depending on wide scientific knowledge to make these concepts employed under control inside the engine to be utilised to provide more output power for the fuel in the power engine.

Hopefully this could be a useful automotive system to solve some future problems through better utilization of Petrol, God's generous gift to mankind and the best, most powerful cheap fuel available in the earth, through this economic design which is suitable for future strict regulations and workable for the computer age to fit the 21 ^{st} century to be declared and invested for mankind's peaceful purposes.

There is still room for improvement in the art.

### SUMMARY OF INVENTION

The current invention is a practical system for an internal combustion engine that provides better utility for fuel's energy by a design that could add more potential powers to engine output with perfect control for combustion intensities inside the engine to perform independently in harmonic effect, a system of different technologies associated in a simple economic discipline with wide options, to reduce the actual fuel consumption or to maximize the real potential fuel output.

### BRIEF DESCRIPTION OF DRAWINGS

Without restricting the full scope of this invention, the preferred form of this invention is illustrated in the following drawings:

FIG. 1: GENERAL SHAPE

FIG. 2: TYPICAL POWER WHEEL UNIT IN HORIZONTAL SECTION.

FIG. 3: TYPICAL POWER WHEEL UNIT IN VERTICAL SECTION.

FIG. 4: TYPICAL SPRING MODIFIED CROSS SECTION.

FIG. 5: TYPICAL THREE-POWER WHEEL UNITS SECTION PLAN

FIG. 6: TYPICAL POWER WHEEL UNIT OIL CANALS, ANALYSIS

FIG. 7: TYPICAL COOLING, LUBRICATION PAD

FIG. 8: TYPICAL PISTON ANALYSIS

FIG. 9: TYPICAL ENGINE PARTS

FIG. 10: TYPICAL DIMENSION OF POWER WHEEL UNIT

FIG. 11: PISTON PUSH-ARM MODIFICATION

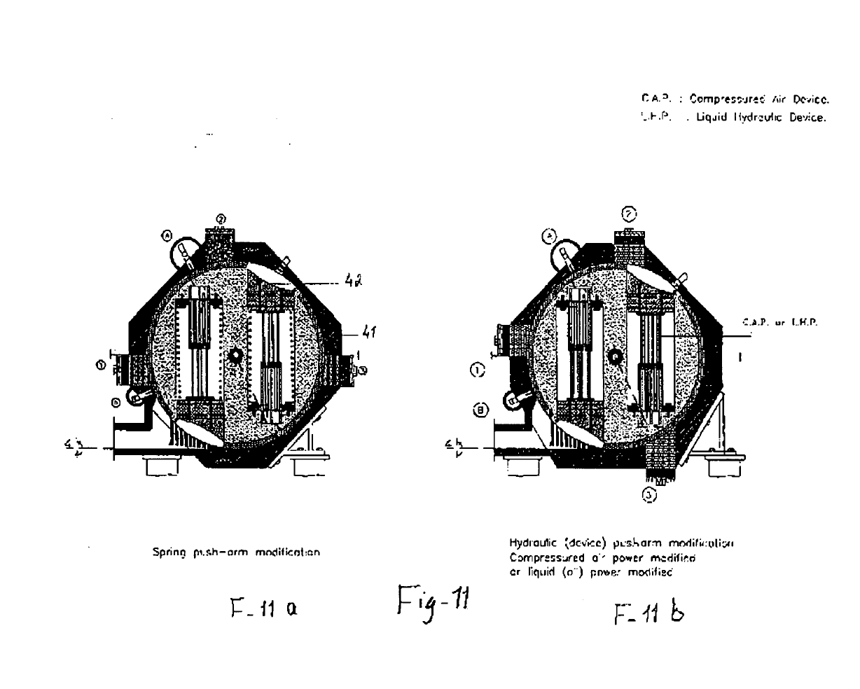

FIG. 12: DUAL CONNECTED PUSH-ARM OF PISTONS

FIG. 13: VARIOUS PROPOSALS

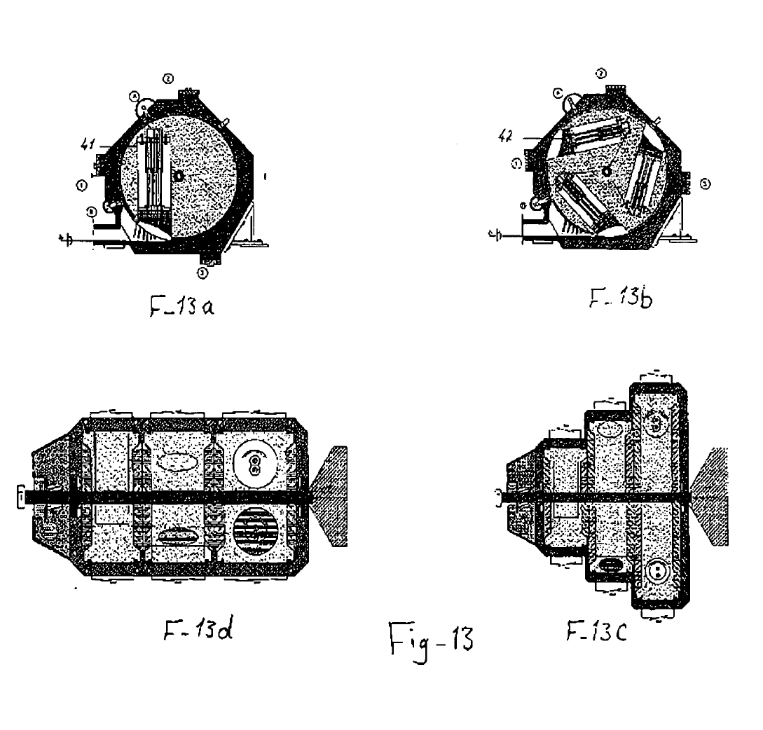

FIG. 14: VARIOUS CYLINDERS IN A WHEEL

FIG. 15: VARIOUS PISTONS DIAMETERS IN ENGINE

FIG. 16: VARIOUS WHEELS DIAMETERS IN ENGINE

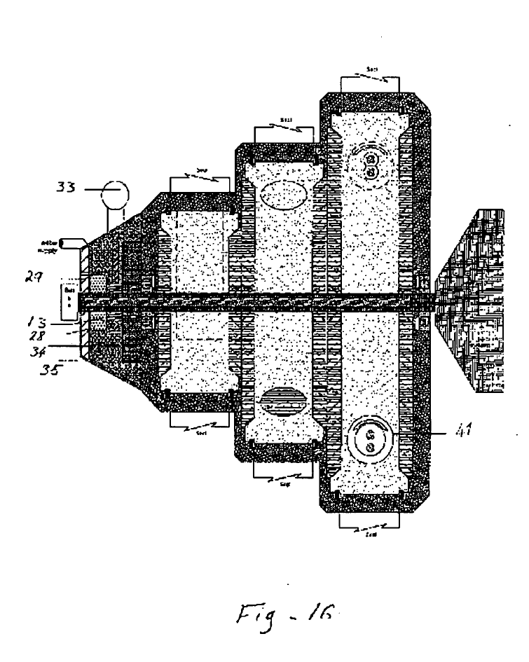

FIG. 17: FOUR-POWER WHEEL UNITS IN ENGINE

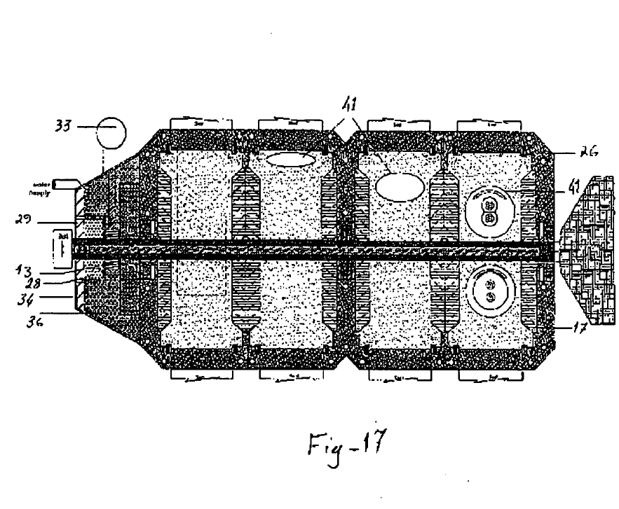

FIG. 18: FORCES ANALYSIS IN THE ENGINE

FIG. 19: TYPICAL ENGINE PERFORMANCE

FIG. 20: A PROPOSAL FOR SEAL-MASS DESIGN

FIG. 21: TYPICAL ENGINE ACCESSORIES, PROPOSAL 1

FIG. 22: TYPICAL ENGINE ACCESSORIES, PROPOSAL 2

FIG. 23: A TYPICAL ENGINE FOR FLYING EQT-VERTICAL CRANK SHAFT

FIG. 24: A TYPICAL ENGINE FOR A WIDE WHEEL

FIG. 25: ALL DETAILS OF THE ENGINE UNIT

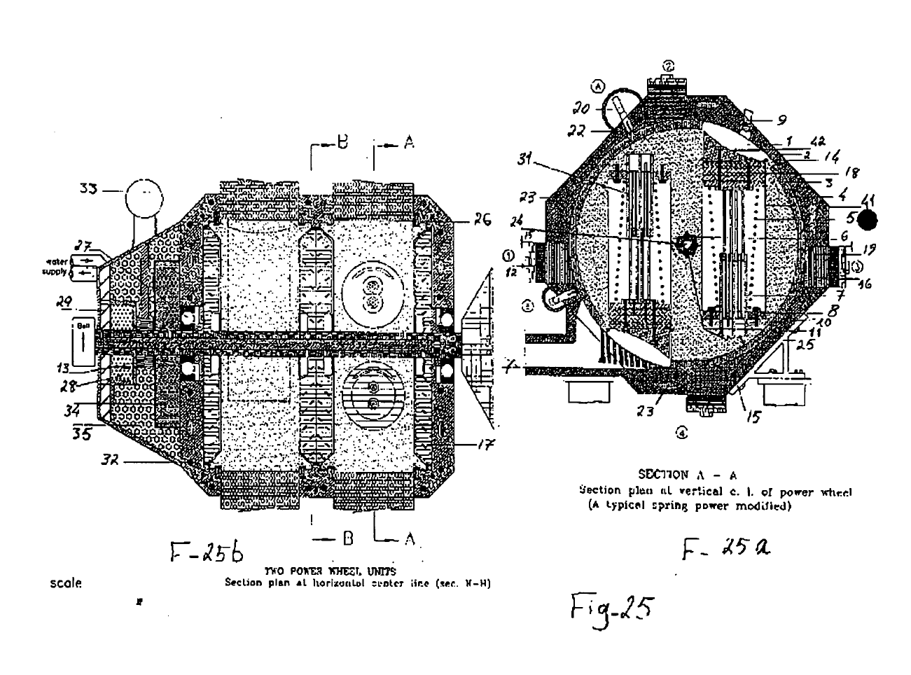

### DRAWINGS DETAILS—DECLARATIONS . . . (IN ALL THE DRAWINGS)

Chamber (combustion room).

Case (engine Chassis).

Wheel (Power wheel units).

Wheel modified circumference (scratch resistant alloy).

Metal spring (straight or inclined).

Crank (torque-crankshaft).

Piston push-arm (flexible shaft device).

Piston push-arm base (cylinder base).

Spark plug.

Piston oil pump (built in with push-arm).

Oil tunnel (canal) for piston oil feeder.

Bolts for fixing seal base (in Case).

Pinion, gear ring to transfer rotation to other device (for ignition).

Solid steel ring for piston lock (in cylinder).

Canal for oil service.

Regulator adjustment for big seal mass.

Pad for oil cooling & lubrication.

Ring seals in the piston.

Big seal mass in Case (anti-gas).

Air-fuel mixture charging device (pre-compressed mix. feeding).

Air charging for exhaust stroke (on chamber).

Valve for air pipe (mechanical-control)./(22d-oil check valve).

Canal for water cooling service in Case.

Central canal for oil supply-in Crank

Engine base flexible holder.

Big circular sliding seal in Case-wheel (anti-gas, anti-oil).

Ball bearing device.

Oil usual pump (for engine).

Water pump.

Exhaust aerodynamic specific opening.

Cladding perforated hollow pipe (for piston oil pump).

Case main assembling bolts

Ignition distributor.

Middle oil tank (feeding tank for central oil canal).

Oil main tank (the engine oil sump).

Oil pump intake.

Oil supply pipe.

Oil refill opening/(for atmospheric pressure equalizer & ventilation).

Oil lock washer.

Tightening ring (washer with pin).

Cylinder for piston in the wheel.

Piston in the wheel.

### DETAILED DESCRIPTION

The following description is demonstrative in nature and is not intended to limit the scope of the invention or its application of uses.

There are a number of significant design features and improvements incorporated within the invention.

The current invention is a rotary internal combustion engine utilizing kinetics energies that exist due to motions of elements inside the engine by implementing centrifugal and aerodynamic physical concepts, during performance of a fuel combustion mission inside the engine; to increase its out put. While such kinetics energies used to be lost as heat and vibrations or fuel energy lost.

This rotary engine comprising a case surrounding flywheel(s) which placed and disposed centrally on a straight axis to rotate coaxial therein, each is containing traditional cylinder(s) of piston, mounted on flywheel center-side, and opened outwardly at its circumference face edge, this piston having ability of free flexible depressing motion inside its cylinder therein with a back linked to its cylinder base by an elastic push-arm; the piston could depress under a reaction of fuel combustion when occurred inside a chamber of the piston cup therewith their places are distributed on circular zone facing the cavity wall of engine case, having free motion pistons that will enable these pistons to be under the influences of kinetics energies which exist during the rotary performance to utilized this characteristic positively for output.

This engine having a network for external managing control using traditional accessories and a designed art for internal network to serve the mechanical activities in order to enable the engine to provide the main features. The engine may demonstrate performance of piston, rotary and turbine together at one time.

The main features are, to reduce the fuel consumption according to power/weight ratio, to provide option of independent control for the engine parts allowing it to be conducted as an automatic performance engine and to treat pollution of exhaust gases by an art designed to be as a built in pollutant treating device in the engine.

S-H-I-R-W-O: These letters define specific characteristics on the engine performance:

(SphericallySpeed-Sustained/Harmonic-Hydraulic/Independent-Internal Combustion Intensities/Rotary-Reflected-Reactions/Wheel(s)/Operating). S. (System).

A new internal combustion compact power engine in a discipline providing smooth sliding mechanism with flexible performance using the fuel potential chemical energy for internal combustion in relation to additional effects due to employing techniques of using Natural Physical dynamic forces inside the engine to provide better output from said fuel.

It is a system consisting of many theories working in association inside a simple mechanical discipline to utilise the maximum fuel energy for automotive power output, with minimum energy lost, in order to reduce said fuel consumption related to power-weight ratio for engine output.

This system is designed to achieve the best mechanical transfer of fuel combustion to automotive reaction, by using all known principles at once with minimum power loss inside the engine. Moreover, it provides ways to use physical effects which appear due to dynamic elements inside the engine to be utilised for its output benefit. This practical engineering design combines types of the recent combustion principles (those used separately to produce automotive power); the piston, rotary and turbine perform together as one compound system in this compact engine unit. In addition, it adds to it new principle of employing the inside physical dynamic reactions of engine's moving elements, all to provide maximum fuel utilisation in output. The system is a simple discipline using wheel(s) mounted on straight crank inside a case to rotate therein, the wheel(s) contains cylinder(s) for piston to move therein, the piston has a chamber defined as the space between piston top and the case internal wall with the cylinder bore surrounding the piston top, the piston is mounted inside the cylinder by free flexible push-arm connected it with cylinder base, to hold the piston and to transfer its flexible movement effects to the cylinder base then to the wheel containing it, with designed ways of isolating chambers, adapting services and conducting the parts in this discipline.

This engine system produces torque power from Hydrocarbon combustion energy, by utilising the extension and pressure of emission gases after fuel combustion in closed chambers. In addition to that, this integral engine discipline will agitate and concentrate physical forces which appear inside the engine, i.e. aerodynamic force of exhaust gases and physical dynamic effects of moving elements, to transfer these component forces as one resultant acting on the same target to apply more potential power to the combustion power of a said fuel. This system is designed to be flexible and harmonic in performance and could use any type of gasoline (octane) for fuel or Jet kerosene or even the gas fuel, dealing with fuel chemical energy in a highly efficient manner and adding to it what could be called the indirect or invisible, inside physical powers (the resultant could be called the spherical sustained reaction). This system uses new technologies to arrange methods for employing natural physical concepts to be implemented inside the engine then invested practically for the benefit of the engine output.

The Principle of this System Design (Back Ground):

The conventional piston combustion engines depend on a set of piston cylinders fixed in engine case (chassis) using reciprocated push-arm between pistons and a zigzag crank shaft connected with them in determined angles by mounting frictional minimising metal pads, transferring torque to the crank depending only on I. C. effect on pistons via push-arms in direct contact movement to produce power.

In fact those systems depend on fuel explosion, but its effect should be always limited relative to the constant piston displacement in cylinders at all times, no matter what the engine situation is. This is due to their designs connecting all pistons with the crankshaft, which is why their main problem is to provide precise ideal mixture control with its complications in order to keep equal displacements on all pistons always.

Those conventional engines depending on the direct reactions of fuel explosion-pressure power happened in the chambers only; depend on articulated mechanism neglecting other effects of physical forces that happen due to element movements.

Although those engines have a high rate of fuel power loss inside because of their machinery (with side-effects as friction, heat, vibration, noise, etc.) which causes a loss in part of fuel output in these engines, there is still no conventional engine design that tries to concentrate the physical dynamic forces that could happen inside automotive engine after fuel combustion mission to use them positively in the engine output.

This new design is seated in a discipline to use potential power of fuel combustion occurring inside pistons chambers as direct contact on its pistons with ability of flexible displacements (not constant displacement) and to transfer any range of fuel power. This is in addition to employing natural physical concepts inside the engine by a design devolving its elements to agitate and then deliberate these concepts, to have their effects acting consecutively positively to provide effective physical potential influenced forces to increase the final engine output.

Theeffective physical resultant power (at a typical mod) due to reactions of:

1. Natural elastic characteristic of elements (elasticity of push-arm and gases);

2. Natural aerodynamic force of gases by the potential effect of exhaust gases; and

3. Natural centrifugal potential power of rotating parts (appears at high speed).

This system arranges ways of utilising physical forces that appear consequently due to fuel chemical combustion energy inside this compact internal combustion engine, in the meaning of making these reactions work for the benefit of fuel output, by concentrating the physical dynamic effects of inside element movements instead of losing them as a lost energy inside the engine (as in conventional engines). This design is seated to employ and utilise natural physical concepts by making them appear within the inside element movements in a way to use the reactions as components acting positively in producing spherical effected resultant on the same target of fuel to apply additional torque on the straight crank of this engine, to magnify said fuel combustion power in output, in relation to the engine design and/or speed and load situations. Thisnew compound concept is working in association with the fuel combustion inside this integral mechanism engine with its easily controlled ways; it will increase the said fuel output or reduce said fuel consumption for any application.

The system mechanism will transfer all physical powers occurring inside engine to a kind of spherical resultant added to fuel combustion which already will be transferred to produce final torque output inside this system in a way that will keep minimum energy (i.e. combustion power) lost inside this engine due to it's simple machinery (recent systems have a loss rate of 15-40% due to their machinery as friction, heat, and noise) which will be affected on the power-weight ratio in output. This system is dealing with almost total potential fuel combustion energy to be transferred to torque power, in a discipline providing perfect adiabatic efficiency.

The system is investing speed as a physical factor to reduce its fuel consumption.

The main achievement on this power system was in existing independent power units in a flexible engine that any part could bear different ranges of fuel power or even stop without disturbing the engine's mechanical efficiency keeping harmonic performance with its ability to have automatic control for engine parts.

This is a system of any piston (or group) working independently to maintain smooth engine performance without disturbing its efficiency to be an auto-power engine unit for various applications. It is a system that utilises the inside-engine potential physical powers for the benefit of engine output and that could counter said fuel consumption at high speeds. The results of this system would show many good characteristics such as: better output performance, less fuel consumption, automatic power, built-in pollution treatment, computer control for the engine activities, and long duration for easy maintenance with variety of design proposals.

All these could be found in this simple fabricated compact engine system.

The Mechanical Compositions & Accessories of the Invention

Compositions as per the enclosure typical drawings of:

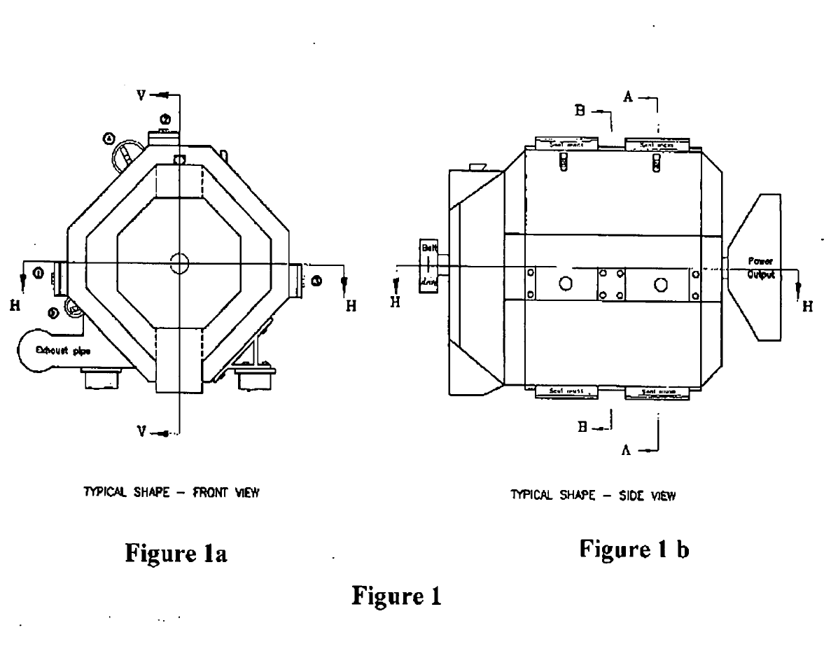

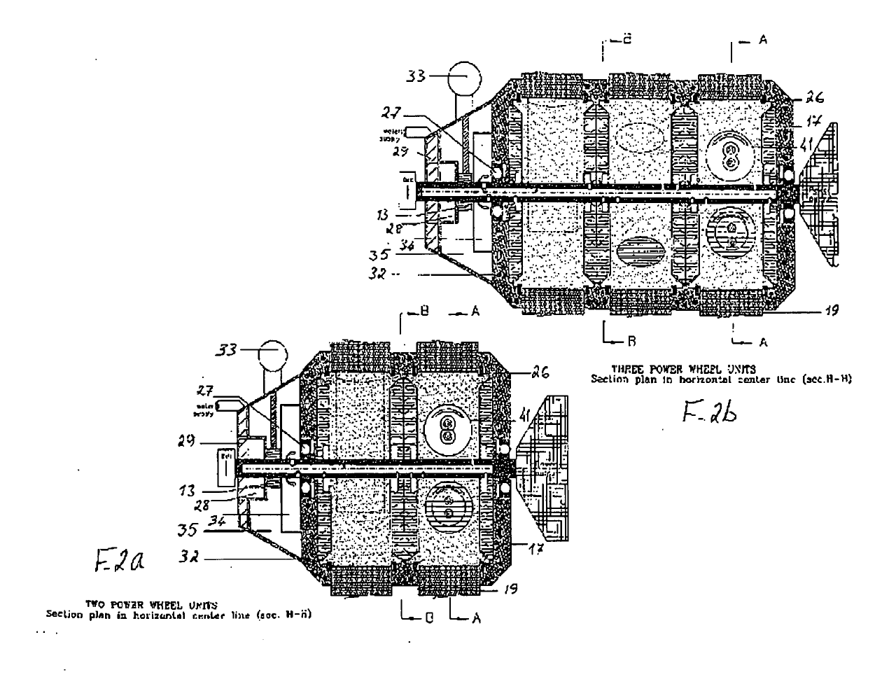

An Engine of three wheel units, of 2 pistons in each wheel using Gasoline as shown in FIG. 1: Outside Case (the engine body chassis): a metal cylindrical or octagonal shape (or as the drawings) with a diameter of 330-380 mm in horizontal position on crank and approx. length (in drawings) of 550-650 mm with a large cylindrical cavity of 301 mm. Contains trenches for seals, tunnels for oil, water and places for valves with special exhaust opening; design and assembly requirements may divide it in parts upper and lower or more, and could permit to cast it in two layers of different alloys with trenches and tunnels as shown in FIGS. 2, 3, and 4.

The crank (as main crank shaft): a torque output shaft is a straight solid steel iron, placed on the horizontal central line of the engine along the Case length and extended more, its diameter being 25 mm-50 mm. The connecting points with the Case by ball bearings allow it to rotate only on its centre line. It contains a central oil tunnel in its centre line and contains holes for linking oil feeding the rotating parts. Its surface is geared (grooved) to interlock and trinket with the rotating parts to coincide and move all together as one system. This is shown in detail in FIGS. 2 & 4.

The Power wheel unit (flywheel unit): a metal wheel (3 in the drawings) in the preferred embodiment is made of a solid strong light alloy wheel, a diameter of 300 mm and a width of 100-120 mm with circular circumference strengthened by scratch-resistant alloy, contains (here) two cylinders (for piston) with an outward opening placed in centre-side in opposite direction perpendicular to the wheel axis, each with smooth internal surface bore and diameter (here) 80 mm and length of 120-180 mm with its central long axis making angle on wheel tangent larger than 45 degree. A piston placed to move in each cylinder adapted with its base, this has two small oil stores (sumps), one which receives oil by tunnel linked with central supply tunnel (canal) in crank for intake oil store to feed piston via piston-arm and the other for outlet oil store receives oil via piston-arm then to dispose it by a tunnel into wheel side. The feeding intake oil store is kept in a full mod always, from canal linked to centre of the wheel within Crank oil tunnel. If required a specific hole with outlet oil store. There are two washers around the crank on the two sides of each wheel for oil lock. There are two edge trenches in the circular circumference face of the wheel fixing a pair of two sides circular wheel gas-oil-slider seals. The number of these wheels, the diameter, and cylinders depend on the design and output ability of the engine applications. The direction of the cylinder's centre line in a wheel differs from a nearby other wheel's cylinder in a known angle that could be found by dividing 360° by the number of total cylinders in performance for the engine. The crank may be geared with wheel according to the wheel numbers for easier angler assembly that starts with all rotating parts in the relevant required angles and then the ball bearings, particularly all rotating parts to be geared on the crank, by pressing them exactly at the designed angles before fixing the crank in the Case position. The manufacturing of power wheels units would be done by casting alloys with modified geared hole to interlock with crank, drilling oil tunnels, trenched on edges, a smoothing circumference and cylinders bore for pistons; these with Case tunnels design would be standard mass production lines for proposals. This is shown in detail in FIGS. 2 & 5.

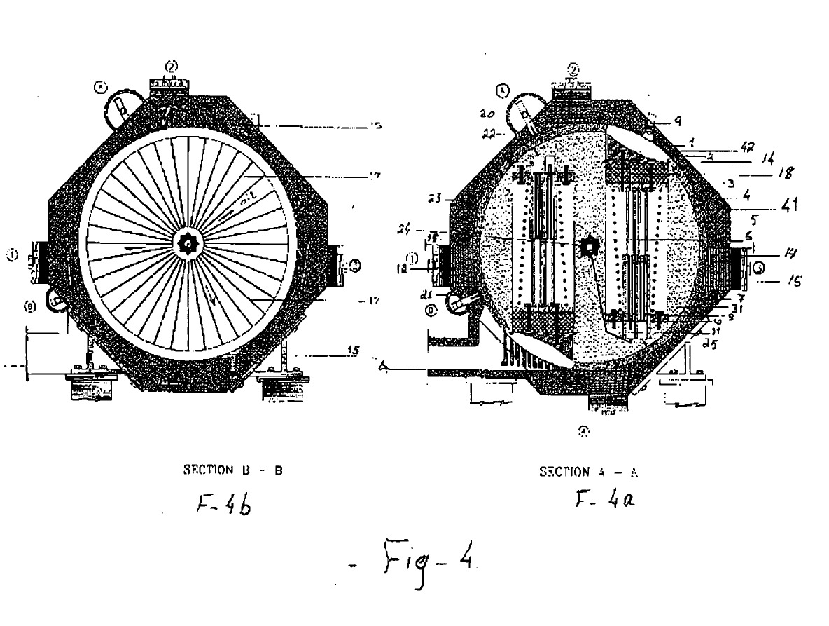

The pistons: each one is from high resistant light disk of solid metal alloy, fixed inside the cylinder with 20-35 mm thickness, nearly the same as cylinder bore. It contains grooves on its circular wall for seals of gas and oil. There are two middle tunnels oil inlet and outlet inside suitable in linking the built-in oil pump on push-arm device from top end with piston, other smaller radial tunnels linked separately with each of these two middle tunnel horizontally to piston circular edge (to oil gap) to cool piston and to distribute oil to piston wall contacting cylinder wall. A special lubricating seal or two in the oil gap on piston wall to uniform the lubrication on piston circumference wall with cylinder wall, for good slipping movement, minimising friction and heat for the main anti gas and oil seals while piston is in movement. The piston is connected by washer-bolts with its solid bearing base plate that caps the flexible push-arm beneath piston. A solid steel ring at the top of the cylinder wall fixed in a groove to lock the piston in the cylinder if required. A suitable curved top capping piston face is required to provide a suitable chamber shape, manufacturing of piston by costing alloy with designed tunnels, grooves and seals, etc. as shown in FIGS. 4 & 8.

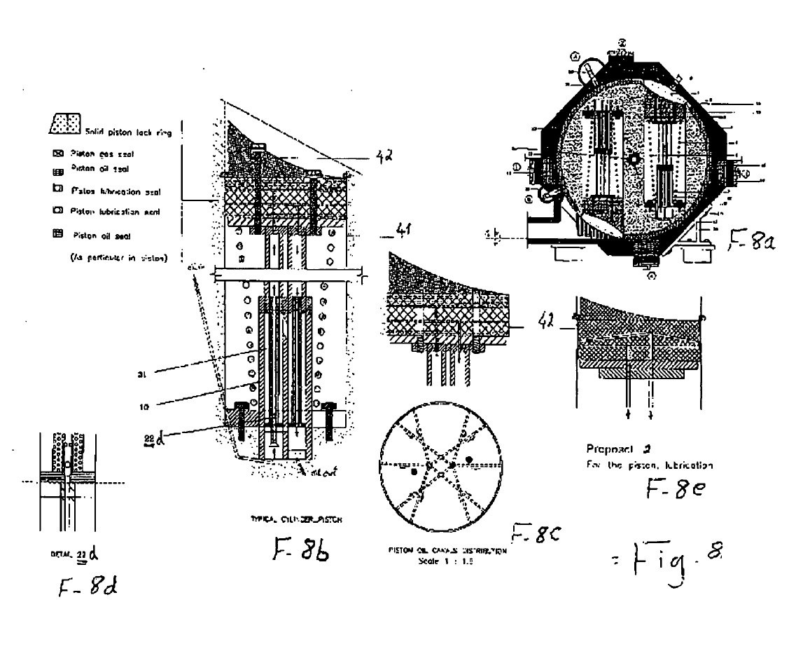

The flexible piston push-arm is two pairs of stainless steel pipes slipping inside each other (or 1 pair) fixed vertically on cylinder base by two washer-bolts. A metal compression spring (straight or inclined) around or a built-in with the push-arm body, is reinforcing the push-arm in which its job is to maintain a linear piston's movement. It is designed to work freely as an elastic resistance for plant reactions (capabilities) for each proposal depending on engine data. It connects the piston and wheel at the cylinder base for linear variable designed displacement distances inside the cylinder cavity, without being guided or guarded by essential mechanical cam shaft in the engine. It could be in gas or liquid hydraulic device working as elastic resistance, i.e. a similar to devices used in automatic re-fill system in fast canons. This is shown in FIGS. 4, 8 & 11.

The oil pump, in the preferred embodiment, for the piston (piston's private oil pump): made from a sliding pair of pipes, each of small stainless steel pipes that slide into each other and contain inside tunnel for oil. It consists of a one-way oil valve (check valve) in each inlet, or in opposite direction (a valve, using solid small ball locked in a longer size chamber of a curved end as a shape of the ball's half spherical shape with a smaller opening and other opening of many small holes to let the oil flows in one direction according to piston movement). It acts as simple rod (shaft) pump due to the piston movement (with push-arm), sucking oil from the main oil canal in Crank via the inlet oil sump in the cylinder base, supplying oil to the piston then disposes it to wheel side-wall. It has a pump of two pairs with opposite flow mounted inside the same push-arm device as in drawings. This is shown in FIGS. 4 & 8.

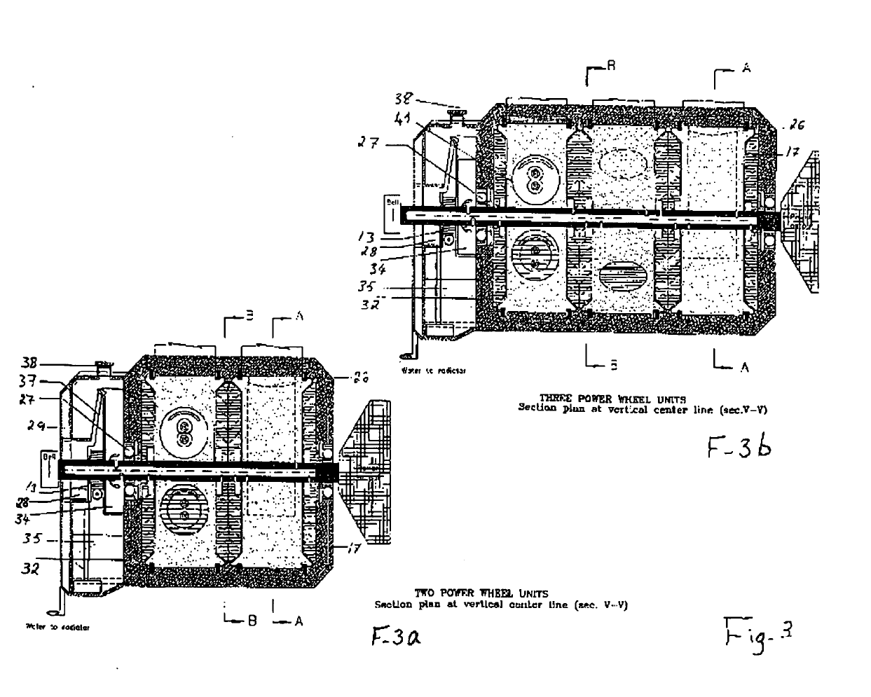

The cooling & oil pads: each one is of light alloy plate of 10-30 mm thickness in a circular shape geared with the Crank attaching each wheel side-wall. It has radial trenches (i.e. grooves) facing the wheel side wall, starting from central zone (pad sump) to the edge outwardly. It coincides with the wheel, which has about the same diameter and to act as a centrifugal pump (turbine), an inlet hole in the central linking oil from crank central canal via crank outlet which coincided with it to feed oil to pad. Then oil is distributed via grooves on wheel walls, cooling wheel side-walls, and then disposed to the circular edge and then to outsider at top portion of Case to oil service tunnels. An air opening in ceiling of main oil tank is provided. The pad contains at its last circular modified smooth edge, lower (or higher) zone(s) in certain places against its relevant chambers, for controlling the mechanism of slipping bar timing mechanism for the engine feeding valves as rotates with the crank against the chambers in the right time, kept moisturised by oil always, providing an independent mechanism feeding for each wheel. Its other duty is to provide adiabatic efficiency. This is shown in FIGS. 3 & 7.

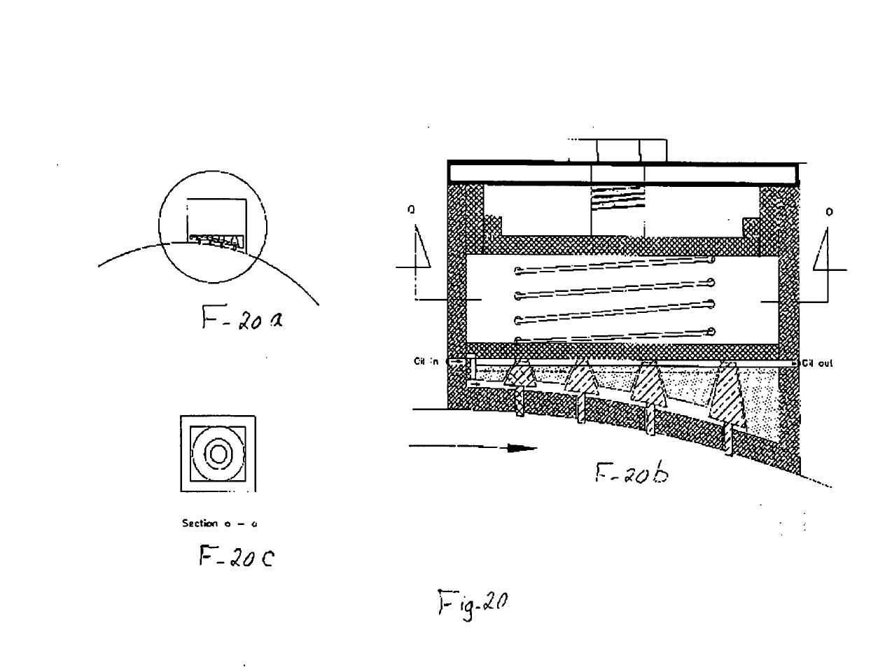

The radian seal masses (anti-gas), fixed in the Case: each from metal alloy (or hard anti-heat plastic or carbon combination) designed according to its work, which is the anti-gas seal attached to the wheel-wide circumference face in coaxial to the Case. The principle of these radian seals by contacting wheel circumference and keep sliding on it, attaching the two circular wheel edge seals (the Case part) at wheel sides to provide a closed situation for any chamber in that portion to keep constant mod (stroke) in that chamber independently for each wheel and preventing gases of chamber from penetrating while its wheel is rotating. A right depth is fixed from outside on the case by a specially locked washer, and each could be adjustable for contacting (attachment) with the face of wheel by a mechanical control spring regulator or automatic thermal regulator. For a metal alloy it could be designed in a special way using linear metal seals, fixed on a base to provide a mass of seal in that portion, with various technique methods of oil services using the advantage of a one-way rotation of the wheels and oil discharge keeping the flow in the Case during engine work. (FIG. 20)

It relates to rotating direction and the existence of special small inclined trenches on the wheel surface in the right places (or on attached pin-mass units) with automatic opening for oil inlet and outlet holes. This could be applied with timing pins in the rotating parts. Using the advantage of one-way rotation to monitor oil discharge from the Case (or on wheel side phase) starting before entrance of the seal and disposes, while wheel rotates at a duration long enough to lubricate attached zone particularly. This could be guarded with spring solid balls in specific places with each mass having a timing system controlled by edge of one side pad of each wheel, (or the wheel itself. Another way is to apply holes in the circular anti-gas seal system; the special timing-controlled opening system depends on one-way rotation that uses circular interlocked parts with holes at these seals. There are special holes on each blade ring that open across as one hole when seal blades meet in a fixed point(s) to set across opening hole for oil feeder from the Case to these seal masses at required places. The direction of rotation and trenches in zone of wheel surface will collect the oil drops rapidly to the inlet holes (automatically opened) by specific techniques on the circular seals which are fixed on the wheel edges before gases reach the seal mass from the coming chamber and before even the chamber reaches the seal position, maintaining surface in a good slipper. However, the gases pressure direction may be used to dispose of the oil in the right time. The number of these seals is 3 to 4 for each ignition's duration, and the radian distance between each one is less than the net radian distance between wheel chambers as the distance of specified attached surface, in any way providing various lubrication techniques depending on the expert of industrial laboratories.

The working principle of these seals in their designed positions around the wheel is to maintain and to transport the locked-closed situation of chamber(s), i.e. keeping same status of mod in chamber while the wheel is in rotation.

These seal masses are in three types of jobs (to work in relative to):

No. 1) for one way anti-gas of air-fuel mixture; before starting the feeding operation on chamber and the place directly after pure air-valve in the Case.

No. 2) for two sides anti-gas, a side for the zone of charging air-fuel mixture, other side for gases of chamber after combustion, a place before power stroke.

No. 3) for anti-gas of the combustion gases at a place before exhaust stroke starts penetration from exhaust opening with particular specification.

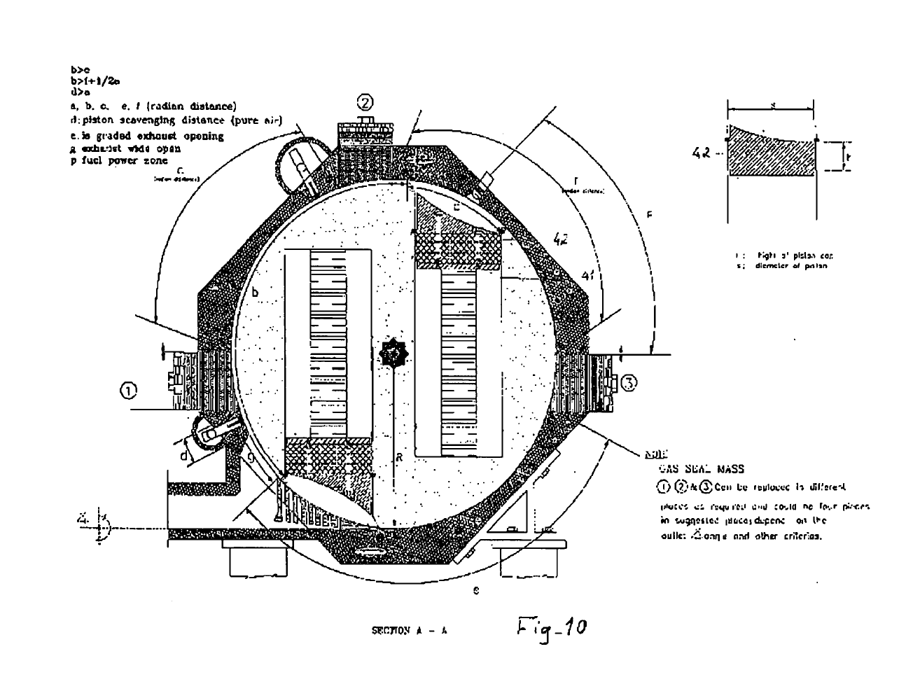

Theessential radian distances between seal masses is shown in FIG. 10.

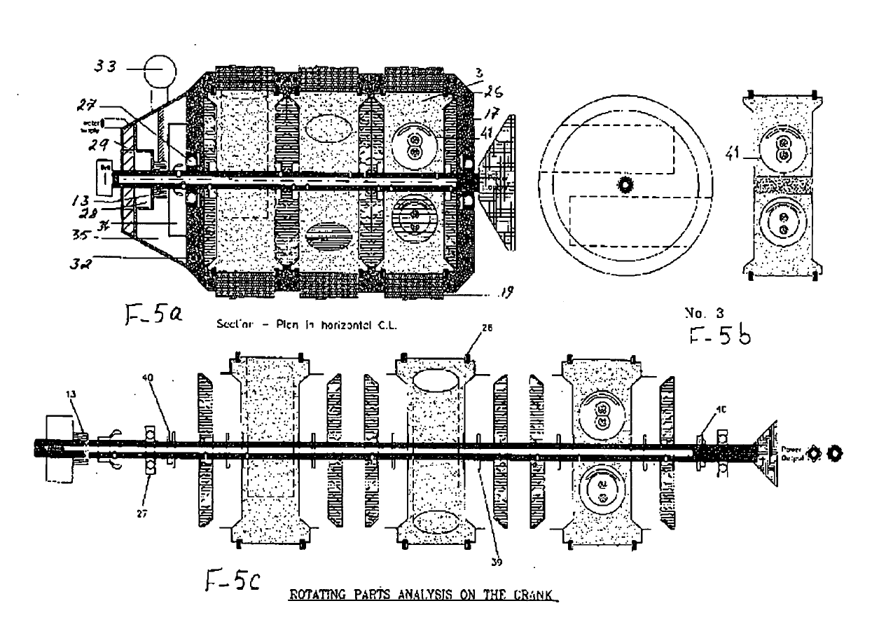

The size of any seal mass could be designed on bigger base in order to allow a piston's maintenance preparation from the Case via this opening without having to open the engine Case to simplify any piston maintenance and push-arm device (also seal No. 3 could be repeated), as shown in FIGS. 4, 5, 10 and 20.

The circular anti-gas seals (wheel-case-slider, seals) on the two sides' edges of each wheel's circumference, designed as required, a suggestion of two or three suitable stainless steel blade rings mass fixed in specific grooves in the wheel and/or with a part fixed in the Case and other in the wheel. To interlock together when fixing all parts of the engine, as separate pairs of ring pieces fixed in the Case, other ring fixed on operating wheel. The seals' components would together form a tightening and a sliding device to protect the chambers from any penetration of combustion gases (and maintain the required closed chamber for all mod of mixture). They could be lubricated with special holes in the right place where there is no longer pressure on it (i.e. end of exhaust opening) or using as self-lubrication seals or as industrial design, FIGS. 2 & 3.

The usual oil pump (and subsidiaries) is fixed in the front end of engine (or elsewhere). It is connected with the crank to transfer oil from lower store oil tank that receives oil flow coming from the Case end to the upper (middle) oil tank. This discharges the intake of the main tunnel in the central crank, in which it has its winging (impeller) parts, in a shape that could direct the flow of oil sucked by tunnel's inlet holes in crank which suck it when rotates to discharge it to pads or pistons in each wheel by relevant holes' outlets depending on the Centrifugal concept for each part. These outlets' holes to the engine parts in the crank are in a specific design for their opening diameter depending on its relevant distance from main oil supply, FIG. 2a. The trenches in each pad, whose grooves will be filled with oil, feed from Crank holes flowing due to engine crank ration directed outwardly from centre by centrifugal energy depending on parts-diameter due to its rotation. The grooves in a way contact side-walls around each power wheel unit, for cooling as for Adiabatic to provide perfect enthalpy system for each power wheel unit. The oil flow will reduce the heat of cylinders after fuel combustion. The pistons get their lubrication oil with the same principle, from a small tank (sump) in the base of each cylinder as intake store. That will be refilled always (if required by specific opening between the inlet and outlet stores with excess length of its intake rod pump tunnel). The demand of lubrication oil for each piston will be supplied as its movement needs. The piston will take sufficient lubrication oil by its lubrication pump fixed in its push-arm that sucks oil with any little movement, supplying the piston needs. It then flows and is directed outside piston by outflow tunnel to outlet sump, then far from wheel centre to wheel side wall. Then it disposes it in the pad zone to be directed to Case by the same Centrifugal concept. The oil grooves and outlets for each pad to the Case as per the design as shown in FIGS. 2 and 3.

The valves of air-fuel mixture and pure-air, air pipe-valves: are of same similar shape with mechanical control on the case. Each is in a separated short pipe device that contains a triangular valve with a wide back opposite to the air pressure supply direction. A triangular or curved shape is against each wheel circumference in the case opposite to a same smaller graded shape opening. It is guarded by a spring. The place is in Case wall at a sufficient distance before firing zone for feeding chambers directed at central of the wheel circumference surface and to be opened at the right time against the chambers. They are controlled by the rotation of cooling pad(s) in a side of each power wheel. A simple mechanical elastic rod system is connected within the cooling pad modified edge. There is a small smooth roller on rod end (which is oil saturated) that attaches the pad differential edge for timing the opening by the meaning of lower (or upper) zones on the pad edge using this mechanism to transport and controls the opening movement to valves. FIGS. 4 & 7.

The air-fuel mixture valve is to supply and feed the air-fuel mix to a chamber.

The pure-air valve is to puff the air to a chamber while still opened for cooling and expelling the exhaust gases from chamber for air-exchanging mission.

The two valves in each wheel are charged consecutively with pressured air by one device into their pipes from the same resource, i.e. pressured air cylinder or centrifugal turbine powered by compressor or by engine rotation as it needs.

The principle of distributing the air between the two pipes for chambers, its differential angles (i.e. different timing), maintaining the required pressure for both air-fuel mixture and puffing on a chamber (or adjusted) at various speeds. The controlling requirement is accomplished by using outlet opening regulator of pressure release for main air supply (a reduction of that opening in higher speed means more pressure to engine) by using this before air enters the two pipes.

The fuel will be splashed at exact mixture or various rate (as required) to charge the pre-compressed air directed to ignition with fuel in order to supply the chambers with fuel mixture before firing it inside chambers in fire strokes.

The fuel splash could be done by a simple spraying device of a needle valve(s) or a simple sub-carburettor or by mechanical or electrical computerised system as indirect injection as pre-mixed air-fuel mixture in feeding engine or in sub-store for each chamber or direct injection at feeding zone on the wheel.

The ball-bearings fixed in the engine Case for holding the Crank by connecting it with Case from two end sides or more as shown in FIGS. 2 & 3.

The water pump is as known in the front side of engine (or out of engine) with its outer radiator and pipes, with Case water cooling system tunnels (canals) to cool the returning hot oil and all engine Case. FIGS. 2 and 3. The air cooling system could be used instead of water with required tunnels or wings on the Case reinforced by air turbine to discharge air towards the Case.

The exhaust opening is in the Case for each wheel: starting with a small graded increase in opening with direction of rotation in special aerodynamic angles, meaning specific wings designed in the outlet of exhaust pipe in order to make the escaped gases at exhaust stroke take penetration position in a perfect way to produce a potential aerodynamic reaction on the wheel to act on the same direction of rotation by using escaping balloon concept. The principle used here is to reverse the flying principle which utilises the fast air produced by plane fan to produce fast air turbulence on the air-plane wings to fly. In this design, an assumption of a fixed fan (the exhaust specific opening) will be under fast air reaction (the exhaust gases, under its pressure and due to piston elastic depressed push-arm). The wheel is free to move (as air plane), meaning wheel will be under reaction of an excess potential power to be rotated, assuming the Case moved in relation to wheel, but really the wheel moves in the reverse situation. This specific opening is connected strongly with the case and exhaust pipe for each wheel and then connected with the main exhaust pipe and could be moveable mechanically for changing its specification and angle depending on various calculations of engine data. FIG. 4.

An Ignition distributor is known, but any contact point has two contact points against each other for each wheel on the circular distributor, as the number of pistons in each power wheel unit depends on piston/cylinder number (i.e. a triple in equal angle if a wheel has three cylinders and so on). Using the same angle distribution for the pistons in whole wheels, each one is connected by one cable to its spark plug. The rotating conductor could (here) face each contact point twice per one cycle to spark two chambers every one cycle, FIG. 3. The ignition distributor could be placed and mounted in a suitable place to rotate by pinion device with the required relation of engine Crank rotation.

An engine of one large wheel with many pistons (cylinders) is formed by using usually one contact point with the same angle distribution and using one cable for each plug and two for dual ignition and so on.

It could be used easily.

A cylinder stores relative compressed air with a compressor pump for recharging and works with the engine rotation by a belt to feed the engine with pre-compressed air. If a compressor in a vehicle could pump its tire with the required pressure, this method could also be used to charge a pre-compressed mixture to this advanced compact engine. A centrifugal turbine fan connected directly with Crank could be used to supply the pressured air to this cylinder. Thiscylinder should have a sufficient air pressure before the first engine performance. The charging air supplements both air-fuel mix and pure air for the chambers, and the types of air temperature could be controlled. A mechanical and/or electrical controlling device for air pressure is connected with the accelerator pedal of the driver cabin. A modified turbo charger may be used instead which is dependent on pre-heated and compressed air by exhaust gases speed and heat but it may not work with the same perfect efficiency for this system which needs pre-compressed mixture.

The fuel spray injection device instrument to splash it in the compressed air uses the simple natural spray principle on a liquid (i.e. the acclimatisation), depending on volatility of the opening and the specific density of fuel. This is the method of indirect injection of engine charging of air while still in its way to chambers. Maintaining idle (very slow engine workability) by electric needle valves works with ignition by electric device. In this way any kind of fuel octane could be used since the flexible push-arms are used also. A mechanical or electrical device system can be used as one unit for all chambers' requirements since it is using same air pressure controlled by a simple accelerator pedal from driver cabin.

A separate pipe-opening regulator for fuel-mix valves in each wheel unit requirement is in using the controlling system for automatic engine or using independent fuel injection on supplying pipe or a store in each feeding valve or using direct chamber fuel injection with its device for each wheel, fixed in the case, as this could be more complicated devices connecting on the case.

The charging air could be pre-heated using a device with electrical heater or utilising the exhaust emission heat by attached device within the exhaust pipes.

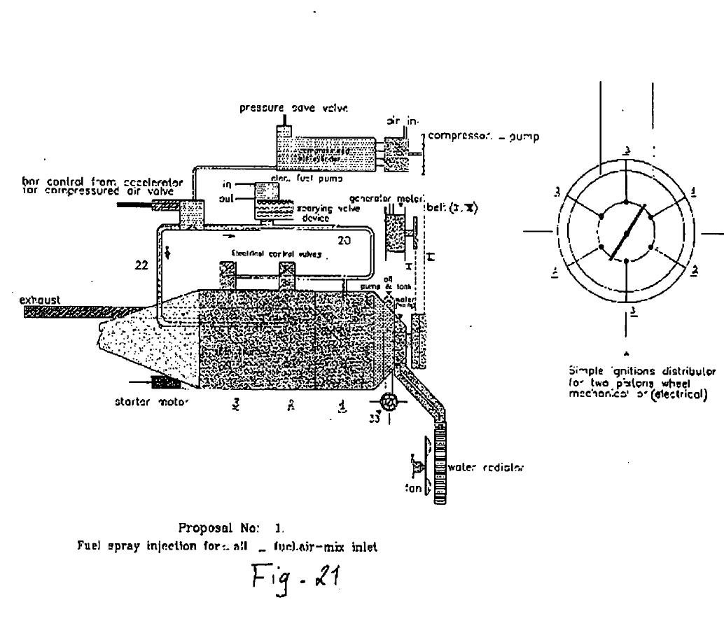

The charging compressed air pipes should bear the maximum required pressure for engine application with a safety factor. (FIGS. 21 & 22 & 23) The assembling method (compositions set up) is starting with the main crank mounting on its already assembled wheels and their pads by pressing together on it at the required angles. Then comes placing other parts and required circular seals on the wheels and fixing them in the grooves of Case parts.

The Engine Output Power Typical Performance

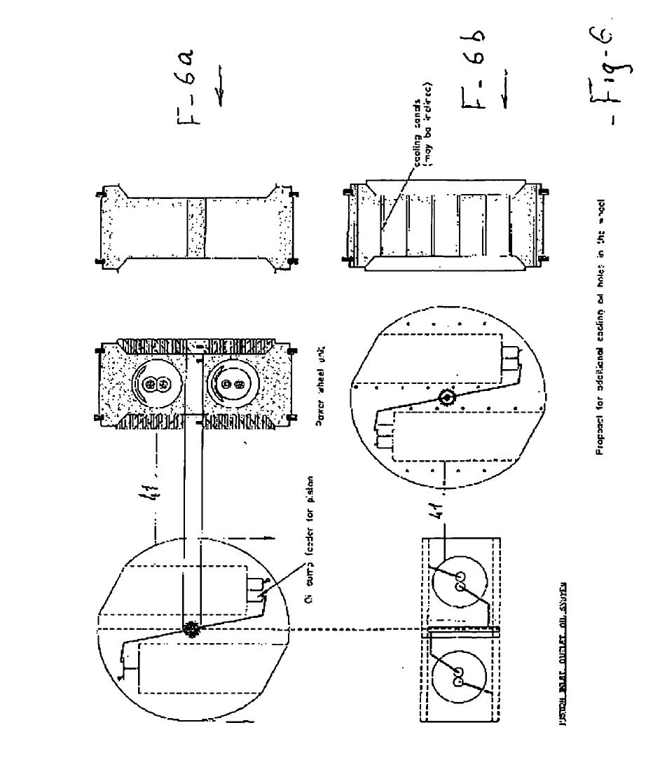

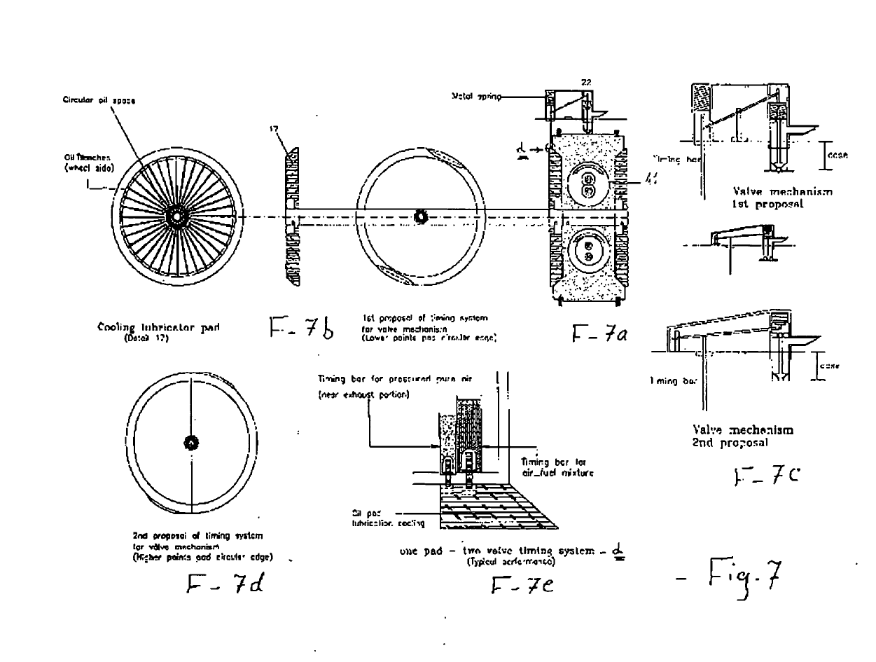

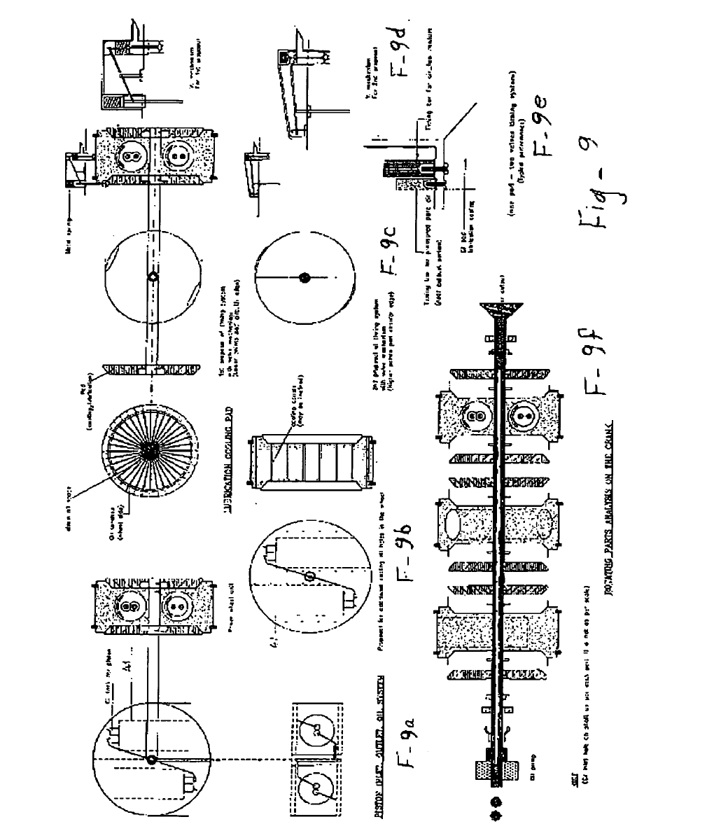

The performance is as follows and as shown in FIGS. 4, 5, 6, 7, 8, 9, 10 and FIG. 18. The engine starts to rotate by a starter motor-accessory fixed near an end side of the engine, by a starter switch for few seconds

All the inside parts will rotate and the valves start the work due to the automatic system of controlling the opening against each chamber in power unit wheels. Feeding the air-fuel mix, controlled by accelerator of driver pedal and its (idle) working feeding or a bit more, to the certain chamber by opening its valve at the exact time with the programmed mechanism by its pad via connected taping bar, the air-fuel mix is compressed in chamber (i.e. space over a piston) and then continued rotation will make this chamber at a place opposite the spark plug (a comparison with Otto system).

*(as suction stroke) . . . piston moves downward . . . in (Otto system)*.

{fuel feeding-charging zone} . . . piston still without move here . . . in (Shirwo S.).

The chamber will be filled with pre-compressed air-fuel mix that it maintains in pressured situations since the chamber is locked by Case wall and piston and radian seal-masses from two sides contacting circular wheel circumference coaxial with Case cavity. As designed, radian position of seal masses for each wheel contacting its circular circumference will keep chambers mod in the required closed situation.

When the chamber reaches the spark plug, the air-fuel mix sparks instantaneously by ignition timing distributor. It will explode to a large volume of gases then put off. Produced gases need to expand to their natural large volume, but they are in a closed chamber, causing high pressure power on surrounding walls and piston. Piston has the flexibility to start moving to be depressed inwardly due to its elastic push-arm connected beneath, to cylinder base, causing stress on this spring in the best typical way due to gas pressure on piston. It then depresses it and then charges energy to this elastic push-arm (the following missions will happen rapidly).

*(firing stroke), piston moves downward, Enthalpy, starting power stroke (Otto)*.

{firing stroke}, piston moves inward, Enthalpy, starting power stroke (Shirwo S.).

When the piston depresses inwardly, the elastic push-arm will transfer a part of this stress to the cylinder base (wheel side), causing rotation of the wheel, depending on its capacity. The rest of this stress on spring will be stored as constant pressure with charged resistance of the piston push-arm to be used later on aerodynamic reaction of exhaust gases (this is one duty of the elastic push-arm).

As part of reaction caused by push-arm acting on cylinder base on wheel centre-side, it will push the wheel to rotate by piston displacement as it moves inwardly due to combustion gas emission keeping a constant pressure in the chamber.

*(power stroke) piston moves to constant displacement . . . high Enthalpy (Otto)*

{power stroke—1^{st} power zone) piston in variable displacement, high Enthalpy, (Shirwo S.). Since firing stroke happens and is finished when explosion has previously burned all the air-fuel mix and has put off rapidly keeping chamber(s) extent space stand still in high constant pressure without flame before reaching the last exhaust seal mass.

Due to this rotation of the wheel, the chamber will cross the exhaust seal that reaches the opening of the enlarging trenches which are graded in the same rotation direction. The emission left gases which are still in high pressure inside the chamber (as the piston is in depressed situation i.e. inward situation), which will cause additional power effect on its wheel due to the rapid escaping of these gases from the chamber via exhaust pipe.

*(exhaust stroke—end power stroke) piston moves up, Enthalpy . . . power loss, (Otto.)*

{exhaust stroke—2^{nd} power zone}piston release, Enthalpy, exhaust power, (Shirwo S.)

The additional stresses (invisible or indirect) which act positively on wheel are:

1 ^{st} the stored energy of spring (resistance) will attempt to be free causing power on gases (against piston) in chamber and due to circular Case inside-wall (chamber back-wall), and the uniform pressured gas physical characteristic of chamber gas pad (still closed chamber while moving along circular wheel edge zone) that will counter the reaction. This potential force will react positively on piston direction which will provide simultaneously additional continuity power to keep on rotating a wheel same direction.

2^{nd} at the time that gases start to penetrate from the graded exhaust opening and are due to start losing some of gases pressure in a chamber, the present compressed elastic push-arm (for piston) which has been already charged inwardly due to fuel explosion in chamber before will start rapidly to return to its first position (normal situation), pushing the piston outwardly again. That will push the remaining gases that are still not totally penetrating to be able to escape faster. This will cause potential reactions on the wheel by the elastic push-arm reaction to get its release situation. It reacts in two directions, on cylinder base means on the wheel and on outwardly piston (to form additional reaction to rotate the wheel).

3^{rd} the locked pressured gases which reach the exhaust zone start to penetrate via exhaust graded opening and will be discharged quickly, causing Aerodynamic force to drive the chamber (i.e. cylinder) in a place that all gases manage to escape rapidly as escaping balloon concept (the flying concept in reverse way, e.g. exhaust opening has wings seated in specific effective design and direction), which acts with more reaction on wheel (additional reaction). So:

*(upward d. pt.) high Enthalpy, entropy by Body only, power loss (Otto.)*

{release piston}, controlled Enthalpy, entropy degree by Air puffing & Body, caused

more effective reaction on power . . . (Shirwo S.).

A summation of stresses will have an effect on the wheel and on this semi-opened position. Stresses affect these parts or parts nearby will be less since the explosion of the air-fuel mix has already finished before in the chamber alone and far from any valve. The same operation will happen with the nearest wheel chamber (by angle radian distance) consecutively and so on as the rotation revolution will continue.

When the gases manage to escape with the rotation of the wheel, the chamber will reach, at the end of the exhaust opening, the pure air puffing valve that opens due to the rotation and tapping of timing bar controlled by side pad against the chamber, to puff a fast pure air, cleaning (scavenging) the chamber from what is left of the gases as exchanging operation (the emission by pure air) in order to expel these gases before the chamber leaves the exhaust opening totally. This helps in ending the expected tacking due to a remaining carbon optical which may exist after burning the fuel mix. This way of cleaning the chamber by air has a great effect in deducing the pollution of un-oxidised gases. It is helping to treat them while still hot and will minimise the expected production of harmful premier oxide gases. The pressure of this air will exceed while rotation speed increases with adjustment to keep chamber always in a suitable temperature for engine situation by this new procedure.

*(suction stroke) piston to downward d. pt. high Enthalpy, stroke & power loss (Otto.)*

{natural stage-air puffing on chamber} control of Enthalpy no power loss (Shirwo. S.)

Then the rotation continues for the next stage, to continue for the comparison:

*(compression stroke) piston to upward dead pt., Enthalpy, loss power, (Otto & old S.)

(feeding-charging zone) control of Enthalpy, no power loss, . . . (Shirwo S.).

In increasing the speed of this system, the radian rotation velocity of the wheel would become nearly equal to a speed of pistons push-arm depression's velocity (resistance speed reaction). This is a theoretical assumption depending on character data of this elastic push-arm, although the high speed will try to balance the wheel.

This means the expanding spaces of chambers will be deduced (for the said engine power) by increasing certain speed, a mathematical criteria with fuel feeding rate: speed, depress resistant, dimensions, fuel, and of course the loading on the engine will be concluded to reduce fuel feeding at increasing engine speed.

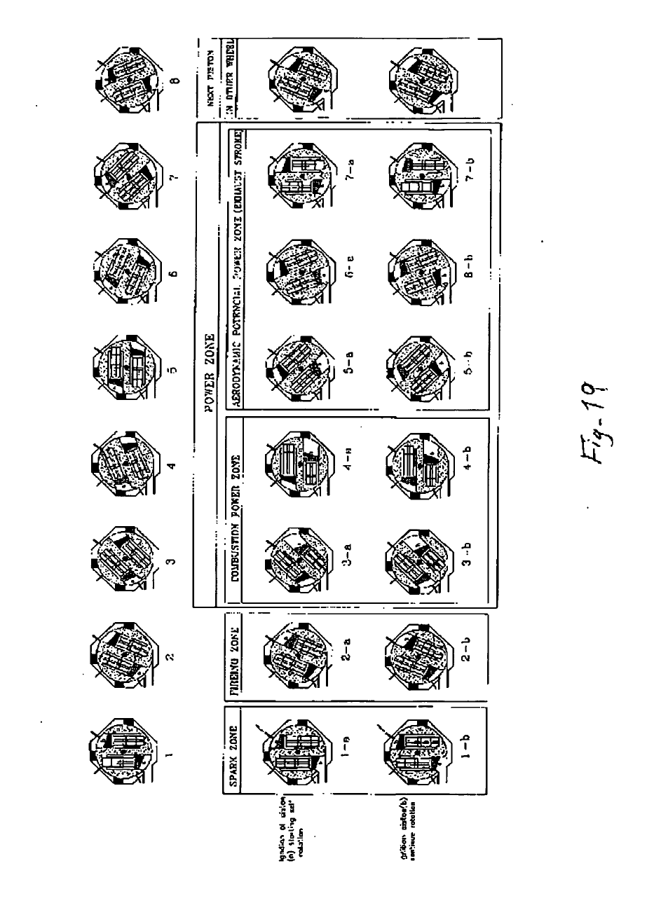

In high speed also, the reaction of the nature's centrifugal power will appear at combustion stage on power zone to act on piston(s) and its chambers consecutively as located almost in circumference of a rotating circle, free to be pushed outward, by this centrifugal potential opposite power (i.e. piston and combustion gases in the chamber, as mass reaction under Newton law), but due to gas pad in a locket chamber (after combustion happened), and existence of Case circular back wall (chamber back wall); that keeping the chamber in constant radian movement maintaining the same constant pressure in the chamber (due to this design and seal places). These pressured gases as gas physical characteristic will reflect as a balloon any power effect on it as opposite reaction of piston to counter it back again on piston (s), then wheel(s) magnifying fuel combustion reaction on engine. It is meant to reduce the expansion of chamber at high speed for the said power, means reducing of engine fuel requirement for the said speed i.e. a criterion for reducing fuel consumption while increasing speed. (FIG. 19).

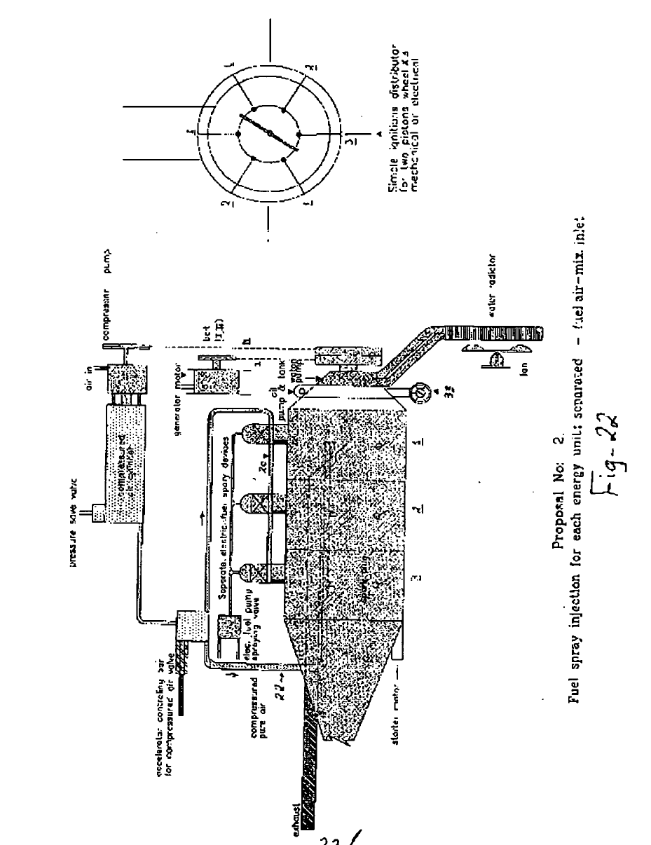

The accessories, as shown in FIG. 21 & FIG. 22, which help this engine to work are:

Cylinder for compressed air: this cylinder should be in a suitable air pressure by the manufacturer before engine start to performance only. Then it will be charged automatically by the engine via a compressor which gets its rotation power from the engine itself by a belt which keeps the air in sufficient pressure. It is to discharge air to the main pipe which is guarded by a regulator controlled by accelerator-bar from driving cabin which is always in closed status when engine is out of work, electrically. It is to be opened when ignition is starting with the slowly-run (idle) regulator. A device controls the pipes outlets. One is for air-fuel mix to get fuel spray for whole power wheel units or to a separate fuel spray system for each power wheel unit, by electric control (computer system) from the driver cabin. The other pipe is for pure air to be puffed on piston and its chambers at end its exhaust.

The fuel spray system is a mechanical and/or electrical device with a needle valve which uses a simple principle of permitting fast air passing on small outlet opening of fuel to produce spray in this air as required depending on Specific Density of fuel which maintains its supply by usual fuel pump (mech. or elect.). The necessary pressured air will increase due to driver paddle-managing system controlling feeding and speed of engine's rotation and torque power.

The other accessories like oil pump and water pump and ignition distributor will rotate with the crank or as for the industrial design. The overall work of power wheel units (as all) output with a remarkable rotation speed monitoring the ideal output of this engine could be changed not only by depending on increasing fuel discharge-pressure, it could depend also on other engine modifications for separating engine's part performance as auto-output.

The basic design technology of this engine shows a main legend which is to enable to employ the well known physical concepts, those which may inversely proportion with an available factor in any engine, that is the ‘speed’ to have them in particular combined physical criteria to be utilized for the benefit of the engine output. The design was plant in association to provide practical ways in highly speeds stages to reduce fuel consumption or to increase the power or acceleration by a said fuel. Also to be able to conduct the engine by independent controlling device to feed the engine (there is no relation with engine activity), although the engine could supply indirect power resource as to assist this device to work (i.e. by a conversion belt). Also it provides ability of independent conducting for each combustion intensity inside the engine without influencing on the others, even on services (oil, cooling). It introduces a unique way in conducting this engine which utilizes legends of the physical concepts connected with the circular motion the of bodies, by using the Kinetic energies and its benefit to overcome the high rate lost of valuable fuel energy in all the present advanced automotive engines and finally in actual use of computer.

This engine depends on many elements constructing its performance, fundamental physical concepts of dynamics, elastic characteristic of material, the best way of utilizing fuel combustion and the best workable mechanical sliding design, these elements are put to work in association to produce better fuel utility output.

The cylinder(s) has flexible piston, mounted in each wheel on the center-side of wheel axis with central line angle (>45°) on its wheel tangent i.e. larger than 45°, a certain force on piston will urge it to deform and transfer part of this force to the wheel then acting like sway pocket to rotate this wheel due to moment resultant.

The air-fuel mixture charged in pressured mode or in supercharging mode. The mixture charge will explode by timing spark plug, nothing will prevent this. The piston is placed in a plant position against the spark plug at ignition timing.

There is one wall in the chamber has ability to move if urged by a force, that is the piston, to start to depress guiding explosion charge impact to be driven on it. The flexible piston in the cylinder is affixed by elastic compression push-arm (ductile spring) on cylinder base, any force impact or increasing it on this piston will cause the piston to depress to inner ward due to the elastic deflection of its elastic compression device connected with. It is by Hook's law of elasticity that means the displacement characteristic is proportional to its force in a straight linear mode. Part of this acting force on piston will transfer to the cylinder base via push-arm causing this wheel to rotate as has sliding periphery edges. This magnitude is in a plant design considering Modulus of Elasticity for push-arm.

The wheel will rotate sliding the chamber's emission contents to exhaust zone.

The principle used here is the same used for explosion concept inside a canon to through a bomb and how to re-fill automatic weapons by its emission's gases. The displacements of these pistons are in different magnitude depending on each explosion charge occurred in their chambers since each piston's elastic push-arm playing a major part in the performance of this system, that is to provide the actual spacing on chambers relatively to the actual required work to be done by the engine in order to reduce the fuel consumption to be according to the exact needs of work.

The modulus of elasticity for each push-arm will play this major part in this system by using different magnitudes in each option even in one push-arm e.g. starting its top (beneath the piston directly) in a sensitive elasticity to let any primer increase of a chamber(s) under pressure (the air-fuel mixture at explosion) to effect on its piston to guide the primer impact to be directed then to drive the whole explosion impact at the piston(s). This is a similar to that old concept still used in fabricating cylindrical gun canons.

The magnitude of modulus of elasticity for a push-arm may be changed gradually directed to the inner ward i.e. to cylinder base as plant, to increase the resistance in a design connected with the whole engine features, by using different cross sections in ductile spring under pistons; to let more effective impact on cylinder base then to on the wheel(s) then producing moment (or as momentum) for rotation. That is explained way the cylinders in this engine have more related lengths.

The pistons will work harmonically inside the engine due to their freely way of fixing them inside wheels with independent conducting feeding supply. This is regarding an important physical concept (a rotating object will need less power to keep on in its dynamic move or even if accelerating it than that primer power used first to change its static to dynamic mode as a relation proportioned inversely with its rotation speed). This is in consideration of all data, type of fuel, and situation of engine in various loads.

For the interrogation on how the aerodynamic effect is existing from exhaust gases by using specific outlet opening. It is by applying that fundamental concept of (Bernoulli's principle) and escaping balloon concept as essentially used to produce aerodynamic force in any rocket. The chamber(s) in the wheel is to be assumed as a rocket's chamber that contains pressured gases emissions (from fuel burnt) to expel from a rocket back side via a designed outlet (opening). This would be guarded be wings to change diameter or the angler direction of this opening to effect on escaping gases to control speed or direction of such a rocket, e.g. (same control has been used in advanced Jet Fighter).

The same thing is applied (relatively) on graded specific exhaust openings fixed on the Case around the wheels periphery at starting exhaust portions of this engine.

That is to construct affixed wings (or moveable by control) on the Case periphery around the wheels at a starting of exhaust zone to inverse the aerodynamic effect. These out lets which shaped by fixed wings will utilizes the exhaust energy power.

Since the chamber(s) in this rotating wheel is containing pressured gases due to previous explosion of air-fuel mixture (occurred before by spark) besides existence of Back Off force from the depressed (mode) elastic spring which is fixed beneath the piston to react, but in dual opposite directions; on piston and cylinder base in the wheel to react also when chamber pressure starts to reduce at gas penetration. The place of these openings in Case starting where exhaust gases are free to expel. The openings orifices, angles, (wings shapes) and the places all will be subjected to a plant aerodynamic design to act intensively at the exhaust zone outlets considering all other data e.g. the dimensions cylinder, the wheel, back off elastic springs, the fuel mixture compression ratio with the whole engine design and its loading.

The chamber structure will be under escaping balloon concept same that used for a Rocket; to reflect then to act on its rotating wheel to add more power, more torque on engine output freely since the design provides this unique ability. This explained how the aerodynamic force of the exhaust gases could be utilized to add more power over the conventional fuel combustion power on output directly. The simplest example is a Rolling Fire-Works Wheel which rotates by reactions of lighting these Fire Works mounted on the wheel periphery on expelling gases, by using this principle.

Exhaust central outlets placed to face the chambers and to be under the effect of aerodynamic exhaust gases, when expelled from the chambers by a design starting (on a rotating direction) by a small opening of sharp designed angle on its wheel tangent on the inner wall of wheel.

The case then followed by others in plant distances with gradually increasing in their dimensions and/or in a tangent angle around the wheel periphery, in the beginning of exhaust zone; to have actual dual effect:

First, on increasing the speed of expelled gases (via small holes) to produce reflecting

aerodynamic force acting positively on wheel. While changing the direction effect during the wheel rotation by positions changes of outlet holes and angles. As to inverse a centrifugal turbine principle, when there is rotating periphery has plant wings surrounding its inner space with a pressured air comes via a pipe to be urged to be driven outwardly in diagonal certain direction crossing these wings. The fast air will act on these wings while discharging out; aerodynamically forcing the wings to move rotating the whole periphery on the same direction

These wings are in affixed periphery as the Case of this engine, and the puffing device is able to rotate by a reaction, then it will rotate, same as the inner freely rotating wheel, containing chamber(s) of exhaust pressured gases urged to expel but aerodynamically to force the wheel to rotate.

The engine performance as combination of piston, rotary and turbine with additional influence of physical positive effect due to movement of elements inside the engine. This design includes fundamental physical concept those which used in inversely proportion with an available factor in any engine that is the ‘speed’ to have some Kinetic energies acting in a particular combined physical criteria to be utilized for the benefit of the engine output depending on conducting way of this system. By employing Newton's Laws of Motion, Gravitation and Centrifugal concepts to be implemented in this engine design same as used in astronomy's legends.

The piston and its chamber (actual piston cup mass) are placed in the open side of a cylinder in the wheel(s) near the circumference. This cylinder(s) is placed in a position to have an axis making a wide angle with its wheel tangent to let a use of centrifugal influence to employ its resultant effectively by choosing an angle larger than 45 degree. The piston(s) will be under the effect of combustion force rotating the wheel, in the same time at high speed to be assumed as an attraction force on the piston(s) which is moving in this circular zone of wheel(s) periphery directing to its central axis, while the elastic push-arm beneath piston(s) urging to push it outwardly by transferring the centrifugal effect of the wheel fast rotating on the objects placed on its circular zone.

The rotation speed producing this centrifugal effect which is as known will proportion inversely with the opposite force as it is here the combustion force (attraction force to the inner zone) on piston(s) which is consecutively occurred in the chamber(s). The force of pressured emission will laterally reflect any force acting outwardly on its flexible piston according to the concept of how pressured balloon could reflect a force (gas elasticity) back on the same direction i.e. on the piston again. But since each chamber(s) is mounted on center-side place of the wheel the final resultant will act on the wheel rotation by accessing additional moment on it, as the angle of the cylinder is considered.

That means also the actual expansion of chamber space will be deducted besides that concept of urging to balance the positions (as flexible) for all bodies which are mounted on opposite direction round a wheel in fast rotation, although there will be a certain force to keep the wheel in rotation but as minimum as required. This means a deduction in said required internal combustion force in highly speeds or a rapid acceleration i.e. deduction in fuel consumption as if compared by the conventional systems. How to use this combined physical criteria, is by substituting relevant determined data of the engine design and specification of fuel used to built the mathematical equations to observe practically the certain magnitude rate of magnifying the fuel energy on the output of the engine for a said fuel by physically utilizing specific movements of elements inside this system as declared above.

However a more efficient fuel power output occurs practically due to longer moment (momentum) effect of pistons with wide torque effective angle on the crank (could be more than 180°).

After the instance of fuel combustion in this mechanical design and according to direct the powers occur simultaneously at fuel combustion in this discipline which employed natural physical concept powers to happen due to the particular places of chambers and by utilization physical characteristic advantage of gases under pressure in chambers those result due to fuel combustion, reactions appeared as: the pressured gases impact on piston, the power reaction of elastic flexible push-arm, would act on two ways. A part pressing the wheel to rotate, and a part acts to get back to its previous mod at the piston top point (upward dead point), as it is elastic push-arm that will be stayed in charge beneath the piston, due to chamber's combustion gases. It is the gas physical characteristic in a closed space, which will resist any force as gas elastic resistance to reveres (reflect) this reaction appositely, which will be back again on piston and since the back side of chamber is the Case circular wall (internal circumference of circular case cavity), which provides away for keeping it rotating smoothly (on constant fixed axis), keeping chambers in locket situation by the radian seals job, while the wheel rotates means keeping a lock chamber in power zone with constant pressure. This means keeping the longer impact effect of this power on Crank. This is the hydraulic reactions of chamber gases inside this engine & the spherical shape advantage in utilizing the chamber pressured gas pad characteristics in this situation by consecutively investing of all physical powers effects happen inside this system to be concentrated on the chambers to be used positively on engine.

A losing of pressure due to gases penetration as gases start to penetrate when wheel chamber reaches the exhaust opening, will agitate the elastic strained piston push-arm (in static mode but depressed situation) attending to return back rapidly to its normal position, it reacts on two opposite directions (dual sides), meaning on wheel and chamber gases to add more power on wheel for torque.

After the continuity of wheel movement and those powers effect, a new physical power happens after this instance due to the way of exhaust wings opening's design. That allows the under-pressured gases to extend partially then totally penetrating in away to get their fast best position of escaping from chamber. With the advantage of existing access power from the piston push-arm resistant being under press that attend to return to its normal (first) position. A Physical power which is the Aerodynamic that forces the chamber to be at the right directed portion while gases escaping. Which will cause additional rotating power on the cylinder i.e. wheel to rotate depending on its place and on the exhaust opening place in this design. It produces aerodynamic power by using the effect of air speed concept (as flying concept put in a reverse way of reaction analysis).

In increasing of the engine speed (i.e. revolution speed) physical powers will appear, instantaneously at the time of combustion and increased consecutively, with influences on the piston (chambers) performance and will effect in two ways.

First, each piston which produces linear force to accelerate a revolution of a circular body (the wheel), which is mounted therein. This will be under a physical effect depending on speed factor, due to this design. The reaction force to accelerate the wheel revolution which is the linear depressing of the piston inside a wheel will be reduced linearly since it could move freely due to its push-arm. That is the more speed in revolution does not need the same primer impact of linear force reacting all the time to keep the wheel revolution in a constant high speed or to accelerate. This means a particular consecutive reduction in potential power of the piston (i.e. the fuel combustion needs) during highly speed, that will be required to produce these impact powers consecutively on wheel. This means the said fuel demand for highly speed situations of engine, could be reduced rapidly while reaching highly speeds and so on. This with other criteria concerning the distance of push-arm depressing formula against the combustion force. A relation to the wheel revolution speed and the decreasing of linear movement of the pistons while increasing this speed, which may reach to the minimum reciprocated linear force effect situation (minimum piston displacement) on the wheel in the highest speed. A physical concept implemented here on wheel's rotary dynamic speed and its acceleration and the linear (piston) force effect consecutively, to reduce these reactions due to speed effect in highly speed.

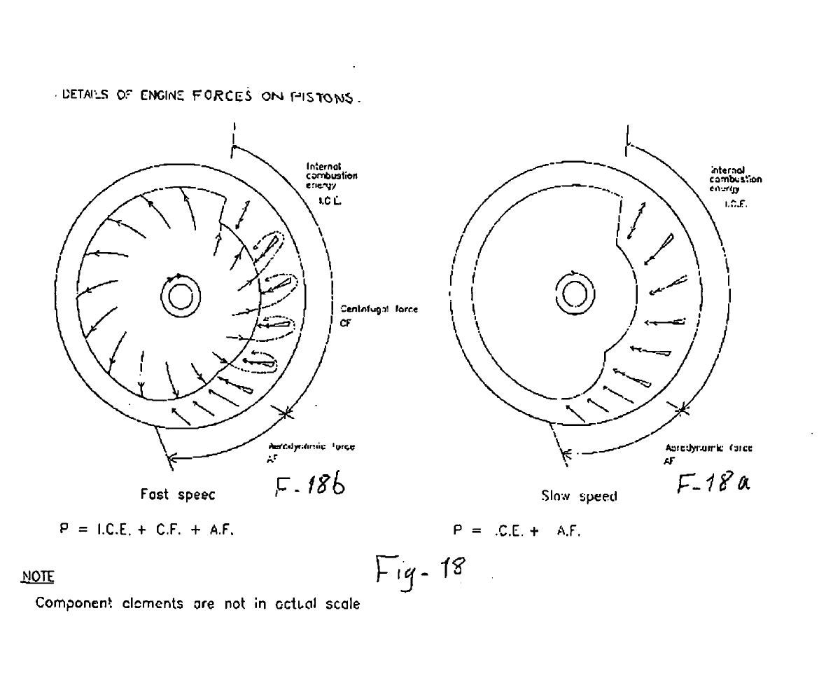

The other effect, is by using the physical concept of how a space-ship is escaping from earth-gravity i.e. a technique which allows a space-ship fly free from Earth Gravity intensity zone by employing the centrifugal concept. This system employed this concept also inside the engine in a very small sample but in inversely reaction, by countering this force. The piston cup (piston top and gases mass in the chamber) is to be assumed as a mass with free movement under the effect of speedy circular circumference zone (as a space-ship and the wheel as earth while increasing its speed). The more speed, the more force to let these masses try to escape from its central gravity in consequence reactions, the under-pressure gases happened instantaneously after fuel combustion in chambers will counter these reactions since the pressured gases in a closed space (the chamber) will reflect this outwardly centrifugal effect reacted from the piston back again to the wheel via the piston face itself by the gas physical characteristic being under pressure in the chamber(s) in a closed space to act like a balloon for reflecting any reaction, back on wheel which is the only free to rotate more as pivoted on crank of engine, adding this additional power to act positively on wheel again. All these influences connected with the physical centrifugal concept employed here. Even the distribution of pistons in wheels and achieving the balanced positions of pistons at highly speed would be considered. These reactions appeared due to employing physical concepts related with the circular shapes of members used in the discipline of this system, the resultant would be called as additional spherically speed sustained reaction on the engine (FIG. 18).

These potential effects are still neglected and lost in the conventional systems. But here is the practical advanced way of reducing the fuel consumption in highly speeds by using physical criteria in such designed power system to use it!.

This system is utilizing a theory, which used in charging water or air e.g. any liquid by a concept of a “Centrifugal Pump or centrifugal compressor” rotates by automotive power resource supplied from outside.

Using the same theory for this design but in a counter way of reaction. Since the liquid used here inside is replaced by a specific one containing potential energy, an easily analyzed chemical energy liquid, that is the air-fuel mixture. This is being used first in this discipline, to produce chemical energy force inside this system to use it for supplying system automotive power requirement. By making this energy acts in a way to make it rotates by an inside automotive power source. Then using the physical reactions appeared in this discipline which is similar to centrifugal pump, due to speed reactions on a mass located on a circular zone, to act on pistons-cup i.e. (mass of piston and combustion emission of expanded gases in chambers), which seated to be under this influence freely to be effected to be driven outwardly consecutively in the meaning of reducing the linear displacement of piston due to fuel combustion without losing its impact on the wheel, as relatively to their particular place on circular zone in this system. This influence will react in a reverse direction in this discipline due to emission of pressured gas pad in chambers to act as elastic resistance as a balloon of gas in the chambers upon pistons to counter this influence to act back again on pistons which are already pushing their wheel(s) to rotate to be as physical additional resultant acting positively on pistons, i.e. engine consecutively at highly speeds. In the meaning of using this new principle of centrifugal concept employed in automotive power discipline for the benefit of increasing engine output by using the reflection of inside centrifugal reaction, to use these as a criteria to increase output power of a said fuel or to increase acceleration rapidly or to reduce the said consumption in this integral engine system.

These invisible (or indirect) physical influenced reactions in additional to the exhaust physical aerodynamic effecting on combustion intensities are due to advantages of circular rotation on bodies and its outcome physical utilization in this system may be called as the spherically sustained reactions.

In the preferred embodiment some of the materials used for the components are identified below:

Light solid alloys for power wheel unit might be reinforced by a hard solid alloy in high torque stress places (i.e. crank-wheel hole, middle panel of wheel between the cylinders, cylinder bases and modified wheel anti-scratch circumference).

Light solid alloys for the piston's disk as the specific industrial requirements.

The push-arm elastic compression resistance capability for piston must depend on type of: engine output, acceleration, speed, application, type of design, fuel . . . etc. The flexible elastic system may be as metal spring or hydraulic elastic compression system could be used (i.e. of gas or oil) with the heat resistant seals i.e. that used in weapon industries as for automatic fast canon refill system. The compression metal spring could be in deferential cross section diameter as to start small from the top then increases within a plant design to let it bears the various stages for different power ranges, same goes to the shape design of the ductile spring.

For radian gas seal mass: could use a self-lubricated Graphite (carbon) alloy or hard specific metal alloy with special lubrication system in the engine case using the advantage of one direction wheel rotation with special trenches and holes. Or specific plastic solid compound material with anti-heat characteristic, the type, shapes and sizes might be varied from different industrial resources, for minimum sufficient contact. Three types of seal mass, for anti air penetration, or use couple of seals for two-way effect i.e. opposite lock reaction in one seal mass unit. Wangle seal could be used in each seal mass unit i.e. not in rotary part here but in the case that provides more efficiency and workability since they will be used in a fixed place acting on a fixed axis maintaining a constant axial positions for contacting wheel circumference surfaces which fixed on one constant axis in this system).

The big circular seals between Case and wheel for sliding and anti-penetration are of couple three or more stainless steel ring bladder inter-lock gathered as a slide bearing ring device or as industrial required or by special wheel's edges with sharp design to inter lock with engine Case, a specific technique as required to reserve the mod on wheel depending on design proposals. (FIGS. 2 & 3).

The oil pads are of light aluminium circular plate alloy with special radius grooves for oil cooling with smooth hard specified alloy edge for controlling timing of valves-bars with chambers positions, the timing control for the two valves in one pad or each in a pad, the timing depends on the design data and other requirements.

Oil is used for lubrication & cooling the power wheel units, this oil could be cooled by water or air cooling sub-system in the engine case or out side the engine.

The distributions of oil and cooling water grooves in the Case are as for industrial design of the Case to cool the engine returning oil in the Case and the engine.

It is a relatively simple and easy to manufacture and less components parts for the engine. High output related to the size and cost, a system contains pistons with rotary operating using the exhaust aerodynamic and other potential power advantages.

Using a new principle in charging the air-fuel mixture to the chambers, i.e. pre-compressed air-fuel mixture, from out side with any pressure needed for the required performance, not as the old principles which sucking the air-fuel mixture to the chamber and compressing it to be in pressured situation by the same piston with its way of losing power stroke and energy and relative slow acceleration. This means using of a jet technique in charging fuel, in this design which will give high performance as fast and better fuel burning as fast acceleration engine needs without limits related to other specifications.

The pistons in the engine is connected with a relevant free flexible push-arm working as elastic resistance, using various resistant types depending on the engine design and power data occurs in the chamber at firing stroke, (types depending on fuel and design). This characteristic will apply good specifications, one of them is in reducing the sudden impact and will uniform stress of high power if occur on any piston(s). In away that these push-arms will transfer stresses of pistons uniformly on the Crank i.e. making the engine smoother, reducing the vibration. The elastic flexible piston depressing will allow a good flame propagation (as combustion chamber space is automatically controlled), and the same reason to prevent detonation in chambers.

The heat energy advantage would tight the flexible push-arm of pistons with heat increase especially in using a gas or hydraulic resistance, which could reduce the elastic movement of pistons and increase the resistance. It means reducing the sufficient capacity of charging air-fuel mix for the same output later with the continuing of working time. This special design will agitate (at fuel combustion) these physical nature's powers to appear in a situation could magnify fuel output to be in the best potential power related with speed in this engine.

The main oil services depends on a natural constant principal with a special design that the oil flow will increase with the speed increase naturally not mechanically (as for conventional engines). This will be done by a centrifugal concept depending on the pads designed groove by feeding from central tunnel in the Crank via relevant holes with relation to its distance from oil tank in engine, this is magnified with speed increase, cooling the wheels and disposing pistons oil. This characteristic will lead to use the far pad in crank as huge oil pump by using high hydraulic specific grooves (trenches), for sucking oil from the Crank to supply oil in the Case for those seal masses needs and to cool Case in a best way. The usual oil pump could be cancelled if the oil tunnels in the case terminate at feeding (middle) oil tank of the central canal. The central canal in crank would not effect on the actual moment of inertia of the crank as its cross section is always circular.

The pistons with their free flexible arms will reduce the reciprocated movement to minimize it decreasingly (the distance between upper and lower piston's dead points); due to increasing of engine speed, in this design. This matter reduces displacements of main engine parts (pistons) movement while increasing speed, (not in constant displacement at high speed as in conventional system!) by implementing physical concept related to a spherical rotating in speed and accelerating by reaction of linear forces effects on it. The reduction of push-arm depressing distance with wheel speed increasing due to engine speed would lead to the assumption of a minimum movement in the very fast speed. It is a physical criterion of the consecutive reducing in chamber's expanding space for fuel at explosion and the way of this characteristic transferred by the same emission gases in chambers to reverse it to act positively on engine output.

This engine system does not contain those valves that used in the old engines with their timing articulated connecting system, (camshaft, gear, pinion, etc.). Those things do not exist in this system i.e. cancelling their weight, noises and expected air smoke related with any of their defect also cancelling their problems of failure that may happen in high speed.

The air-fuel mixture quality can be controlled easily in this engine from out side accessories, in two ways by controlling the supplying pressure and also by controlling the fuel mixture, or both together depending on design data, however the system may not require a same (ideal) uniform fuel compression ratio in all its chambers or in all of its working stages, since independent pistons performance characteristic with their ability of various displacements providing flexibility in the engine to make this system easily uses different types of fuel efficiency, any gasoline (Benzene)octane, or Jet gasoline or even Gas fuel could be used after reconsidering the mixture accessories requirements for charging these fuel.

The cooling chambers and expelling exhaust gases out of it by puffing air (scavenging) directly on it at the end of exhaust stroke. This will control the heat of piston cup and supplying perfect adiabatic efficiency of air cooling technology for pistons in addition to the wheel side-walls oil cooling & enthalpy of cylinder walls. The air also will prevent the remaining of after burning carbon (soot) and will complete to oxidize unburned carbon oxide gases i.e. (CO) directly to (CO2) or (H2O), same to complete oxidization for the sensitive nitrite oxides (NOx), (and SO—if exist). This practical way for anti-pollution treatment technology inside an engine, in a way to help conserving the environment and to prevent occurrence of harmful acid rain in industrial territories, all these missions could be under a perfect control. When there is no sufficient time to complete expelling exhaust gases of a chamber in a highly speed, it is possible to make this mission repeated for each twice revolution of this chamber, by having a management (as this system permits for that) to make the fuel feeding for it* to be for each double revolutions consequently & harmonically.

There is a perfect way in lubricating the pistons that only the moving one will be lubricated when it needs to. In the preferred embodiment, each piston has it's own private oil pump, and the lubrication system designed in away to reduce too much the pollution of air-oil smoke, since no crank case-oil sump bellow the pistons.

There would be an air pad(s) under the piston(s) that could use its advantage in a special piston design to maintain a sufficient pressure in high temperature beneath piston to use it to be utilized for longer seals maintenance period and for output. This way could be connected for dual piston effect in one wheel.

The distribution of the piston (cylinder) angles in the central crank in the engine will not need a balance weight. These are not required in this engine system. The way of emission gases exhaust rapidly with the circular rotation's direction will minimize the stress on stroke final seal masses and helping a good lubrication mission for all seals. This is a specific design in distributing pistons with its unique way of piston free movements while rotating the Crank (torque crank shaft). The principle used here will not need to distribute the stress for every combustion (piston) unit, as for old regular engines in all working time. That happened in the old system which all connected with a zeg-zag crank shaft; each one with its special angle in slipping point guarded with metal bearing pads. Meaning all the combustion pistons will move consecutively (mutual) side by side equal, in the cylinders due to the rotation of the crank shaft, all the time, this increase with speed acceleration causing more friction, heat and vibrations, more lubrication need, which all affect on the engine efficiency. This new system is not working on that old principal, it reduces piston(s) movement in a counter way with the increasing of speed, due to physical concept implemented on this discipline, to reduce speed effects on engine, even it can reduce the fuel consumption in highly speed using advanced controller systems depending on the criteria of rotary wheels and their pistons harmonic linear movement and its performance on certain speeds &applications.

The best seen characteristic for this engine is the multi-output powers which can be changed in various ranges not as by depending on the revolution speeds of the engine but on the required movement of the working pistons inside the engine (automatic power parts output). Like for example all piston in used supplying 100% output of the engine for heavy work in vehicle engine (4×4 wheel in work), or ⅔ or less parts in used for high speed or ⅓ or less parts in used for just to keep the engine in Idle working situation. This could be done in away that even its oil services could be stopped by controlling their relevant pads centrifugal outlets. This characteristic is very useful: in reducing actual fuel consumption, reducing pollution and providing longer maintenance. This engine can be produced as engine for every work (as multi-purposes) in one equipment (i.e. one vehicle) which is automatically suits various ranges of outputs requirements, without effecting on unused parts or causes tough vibration, (i.e. automatic output engine) as for different requirements on horse Powers e.g. excellent use for automatic demand for 4×4/AWD (All wheel drive). The current invention is call HIRWO+Automatic Need auto engine will be called (SHIRWAN) SYSTEM {S.H.I.R.W. Automatic Need=SHIRWAN for automatic-power-output engine}.

The heavy transmission gear complex in this engine could be minimized or even terminated but of course keeping the reverse position available.

Since there is the ability of stopping piston's movement in this design while crank continues in its rotation plus the circular slice machinery.

In an alternative embodiment, the engine could be combined with an electric power engine mounted on the same crank or by clutch as advanced engine design with very practical use, it is a fuel combustion engine with electric power engine in one unit set. Based on the simplicity of this design, the engine can charge an electric battery when it is working. The electric power engine could be used directly instead—if it will be required when a situation needs i.e. a crowded city, to reduce the pollution. This is a piston-electric output (combustion-electric) in one combined engine unit.

In addition to other characteristics, proposals and options which can be obtained in industrial laboratories this machine will fill the gap between the normal piston combustion engine, and the turbine Jet engine using their-all-good characteristics together in one engine unite, it will use the good characteristics of combustion piston (and rotary) engine in economic fuel consumption, slow rotation speed if required, small engine and easy to manufacture and maintenance, with the Jet characteristics of high power, high accelerated speed if required also by using the aerodynamic power of exhaust gases with other physical potential powers; all in this integral design and cheap engine.

This design will open the wide gate for the computer participation in controlling all engine activities and its characteristics performance by using advanced controlling accessories with economic industrial influence in the age of computer.

This engine could work in a vertical direction engine related to the torque crank since most of engine oil services depend on centrifugal concept related on speed.

Based on the important characteristics and the ways of reducing fuel consumption rapidly with high speed increase, this will lead to use it mainly in high speed equipment that needs less reciprocating piston movements makes the current invention makes it very qualified engines for Hoover Craft or flying equipment.

### Alternative Embodiments

The engine could contain many power wheel units depending on the out put torque power, with a relation to the diameter and number of cylinders in each wheel, the various proposals and options of this system provide extensive use. The power wheel units could be in different diameters for kinds of engines, the principle of piston's moment effect on the Crank will be considered in related to output power using the required wheel and cylinder diameter in any engine design as these are some engine options. (FIG. 2)

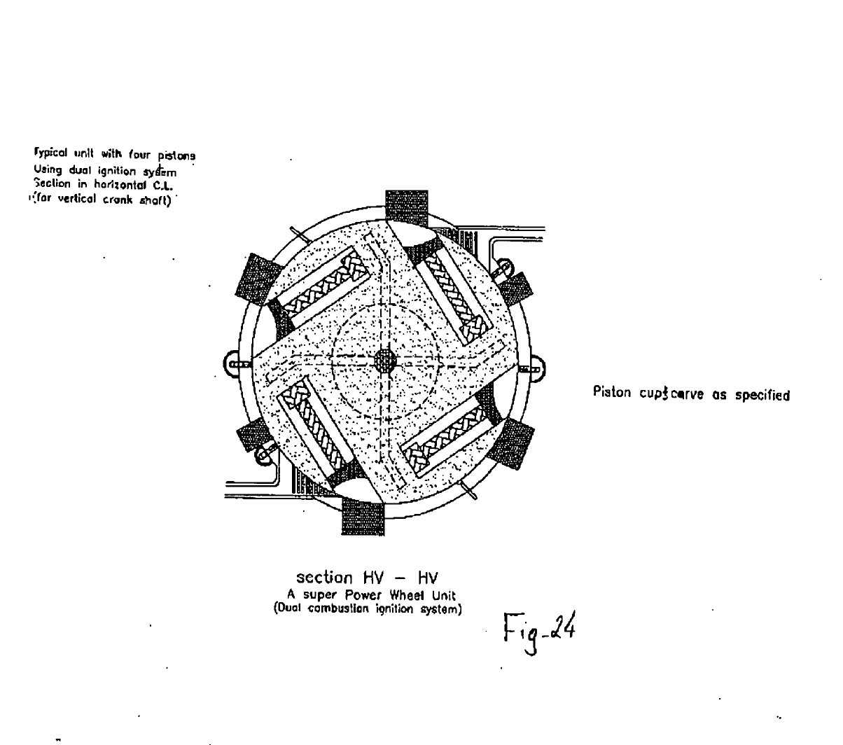

The engine could use double ignition systems (accessories) in one large (super) power wheel unite, one or more in an engine, could be used as some engine options. (FIG. 24)

The main canal (tunnel) for oil supply in the crank could be seated out side the crank. A longitudinal tunnel connected parts on the crank as a canal across all parts (that stickmen together), parallel to the crank line as its boundary, with holes for each part, for oil feeding, considering the main intake and parts balance. The oil supplied for radian seals by specific tunnels in the case via modified pad.

The water could be used for cooling power wheel units by a specific design for the Case with more extensions between the wheel units containing canals for water, or using air cooling system, as these are some options.

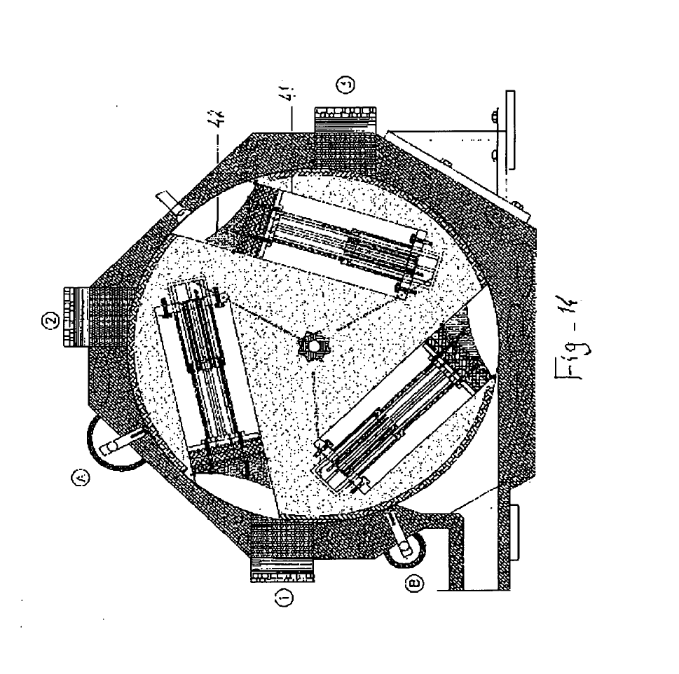

The difference of cylinder number in a wheel depends on the diameter and speedy output power of the engine as these are some options, (FIG. 14, 24).

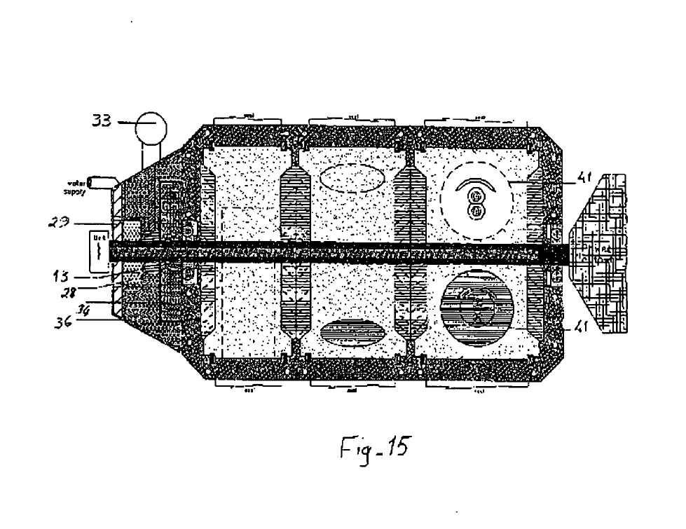

The cylinders in each power wheel unit in the same engine could be in various diameters as a specific in each wheel with relevant accessories as required for Automatic power engine, as options of Auto-Engine, (FIG. 15).

The fuel spray system can be in one set for all air-fuel mix by a pre-mixed fuel feeding the valves, or could be separated pipes control for each power wheel units in the engine, controlled by advanced computer system, as required for Auto-power engine. They could be substituted by a direct fuel mixture injection on each chamber by additional Case fixed device for each wheel. (FIG. 21, 22).

The fuel spray system could be controlled by a computer system to monitor the required spray mixture with air and could vary this mix for each type of gasoline octane by automatic device as required for multi-purpose Auto-Engine.

The exhaust opening could be in different grade openings and angles related to engine design and fuel criteria and could be in mechanically changeable design for wings grades and directions by a mechanical device control.

The exhaust opening could be in opposite direction depending on the Case design.

The flexible (elastic) system of piston push-arms could be in various types for different engine design (or even with differential diameter along one spring) using metal spring, gas or oil hydraulic device—heat resistance—like those used in automatic gun weapons, it might be more tight and qualified by heat increase.

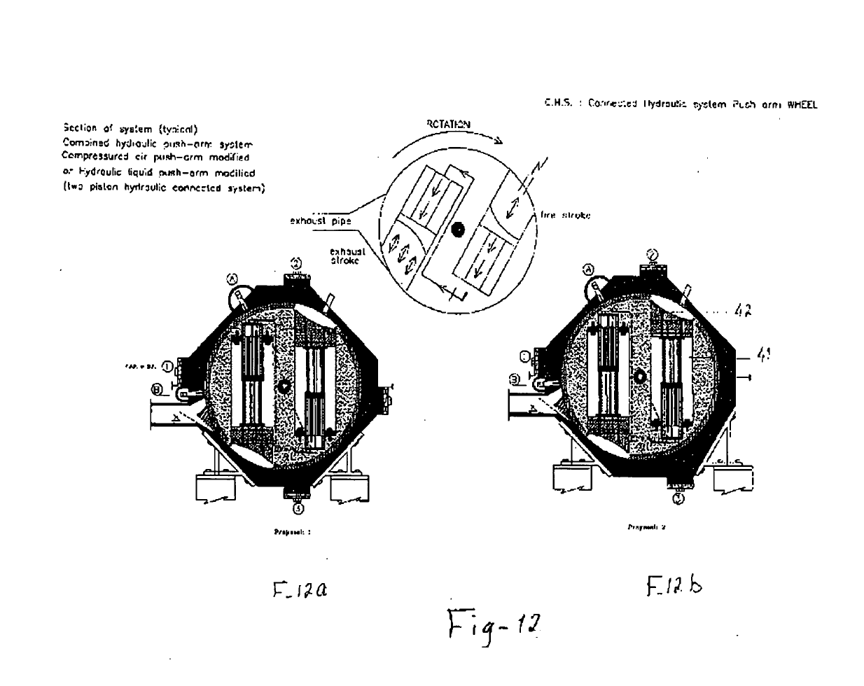

An advanced new modified system under the name of (connected hydraulic wheel unite system) could be used, that can get use of the impact power on a piston at firing stroke instantaneously to transfer a part of this power to effect on the opposite direction piston in the same wheel at a position when its combustion gases (of the previous piston) start to expel from exhaust opening. In a way to supply impact force from inside the cylinder to push piston outwardly faster for rapid expelling of those gases out of the chamber. Accelerating them to be released faster from the aerodynamic graded opening, producing more reaction on the opposite direction on the wheel increasing the turbine power. This is a technique of a connecting hydraulic system of two pistons. It could be working also between the spaces beneath pistons in one wheel. It is advanced modified option to be as a part of the development researches on this system. (FIG. 12).

The central oil canal in the crank would not effect on the moment of inertia of circular cross section crank, as this depends on the size, diameter and metal capability of torque resistance of Crank related to its canal diameter. The usual oil pump could be cancelled in a design that could make oil tunnels in Case driving oil to the middle oil feeder tank that feeding central oil tunnel in the engine crank.

The mechanical ignitions distribution could be in advanced electric device. It might need also additional timing device as for old system but with more simple method, and even could use clever computerized device or (Laser) due to the fast rotation of the engine as a part of advanced developments on this system.

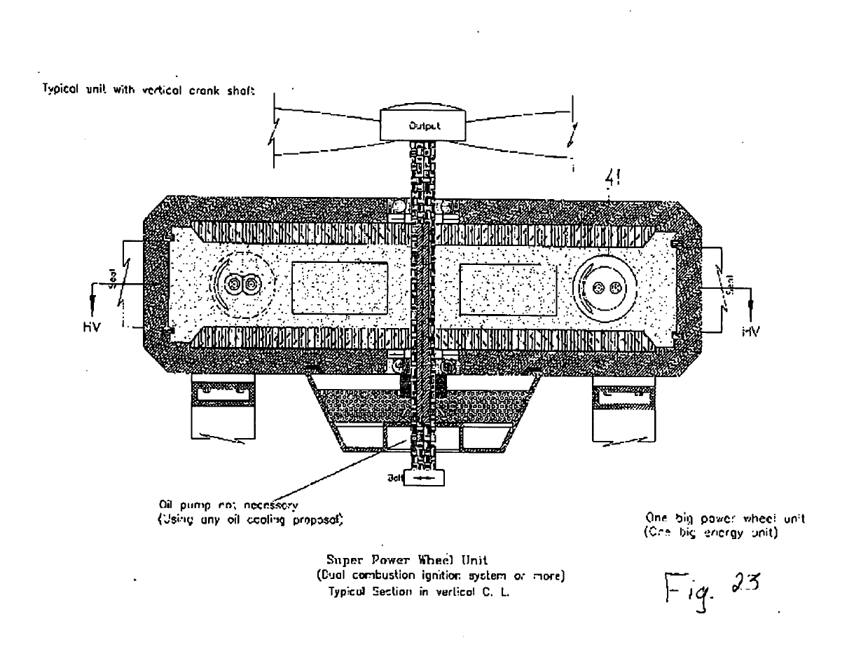

The engine could be designed in a vertical crank (shaft) direction on the same system principal. It is because of most oil services are depending on the centrifugal energy which could work in any direction, the engine oil pump could be cancelled. This means it could be easily used for flying equipment or Hoover craft regarding the simplicity, the speedy efficiency, the output power and the small size. this promising generation of clever engines could be used for advanced small Hoover craft (or a composite vehicle as Automobile and Hoover Craft or running and flying transportation equipment) by implying this cheap system with using of recent available advanced computer control, (FIG. 23).

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A rotary internal combustion engine shaped like an electric motor, comprising a case 2 having cylindrical cavity contains at least flywheel 3 of smooth circumference width, disposed and geared on a straight central crank 6, to rotate coaxial inside the case therein, the flywheel contains at least a cylinder of piston 41 or manymountedoppositelyon centre-side perpendicularly on crank at central line angle 45° or more on flywheel's tangent as openedfrom this side outwardlyonflywheel circumference facing case cavity wall, a piston 42 inside it with ability of flexible linear motion therein linked to the closed end of the cylinder (cylinder base) by a self interlock rods or more enforced by a spring or an elastic device defining piston's push-arm 7, the piston's top face together with its cylinder's wall and its facing internal cavity's wall defining the combustion chamber 1, a circular seal 26 surrounding and fixed on wheel circumference 4 ateach edge side interlocked with the case, at least three of seal mass 19 facingwheel circular width in a designed fixed radial locations on case cavity to isolate stroke performance modes of a each chamber during rotating of flywheel thereon, each chamber conducted with the rotation to be fed by air-fuel mixture from inlet 20 via valve(s) 22, to pass on spark plug(s) 9, for exploding its fuel-mixture charge at a relatively longer zone located away from inlet valves, charge explosion will make its piston deflects or depressed downward transferring power of gases released from the explosion to the flywheel side causing torque to rotating, while passing other redial seal to reach the exhaust opening 30 that contains modified wings designed to provide aerodynamic effects based on employ Bernoulli's Concepts to make speedily exhaust gases expel through out while reflecting relative aerodynamic reaction on the same discharging chamber which will be as a packet for escaping gases to be pushed back ward i.e. on the direction of flywheel rotation adding more power on the rotation, supported by the already depressed elastic push-arm of the piston therein, then reaching the final release exhaust opening where there is air puffing inlet 21 to clean and scavenge the remaining exhaust gases, to have other new revolution, a compressed air will be fed into feeding inlet 22 after spraying or injecting fuel on it by a device 20, compressed air feeding for the two inlets 21 and 22 by one network of accessories having air store and a compressor, an ignition distributor 33 conductedwith crank rotation adapted to link with the spark plug(s), Inlet valves 21, 22 mechanically timed controlled by edge(s) of circular metal pad(s) 17 whichsurrounding and coinciding sides of each flywheel which also used for oil transport and cooling services containing radius grooves to discharge oil outwardly from inlets at central oil canal 24 to link the case, depending on centrifuge concept during engine rotation, piston oil servicing via canal passes through piston push-arm 7 discharged relatively bysliding rod-pump 10 works with piston linear up and down motion, linking piston's internal oil network with its flywheel oil intake via holes on central straight crank thereon, oil returns back via case network by discharge and gravity to main oil tank 35 at one end of the engine where a normal oil pump is there to supply the central canal in the crank, a case could be disciplined to have many said flywheels with different dimensions each one could work as a separate independent power unit in the engine controlled by independent accessories to form an automatic engine.

2. The engine as in claim 1, further, composing one of a set of three types of combustion system as Piston, Rotary and Turbine, in which all together could perform typically in a compound integral associated unit designed in a simple mechanism to provide best utility of fuel potential combustion energy to transfer it into automotive power output.

3. The engine as in claims 1, further, where all piston displacements in any direction will act positively for the output benefit during performance that will provide potential power for the engine.

4. The engine as in claims 1, further, using speedy exhaust gases to create potential aerodynamic reactions by using a technique of aerodynamic concept at a modified exhaust openings to reflect a relative power positively for a benefit of output.

5. The engine as in claims 1, further, using pre-compressed air-fuel mixture to boost it vertically on the axis of modified flywheel(s) contains flexible piston(s) chamber(s).

6. The engine as in claims 1, further, using the pre-compressed air-fuel mixture to charge it by almost independent device to the chambers.

7. The engine as in claims 1, further, using the principle of Puffing air on each chamber directly at the end of exhaust stroke while still hot for expelling (scavenging) exhaust gases, to reduce heat of chambers in each cycle.

8. The engine as in claims 1 further, puffing pressured air directly on the hot gases in each chamber while still hot at each end of its exhaust stroke.

9. The engine as in claims 1, further, using flexible elastic push-arms for pistons with the free various elastic displacements as this discipline utilizes them all positively and effectively on the engine output.

10. The engine as in claims 1, further, feeding the air-fuel mixture to each chamber as in the same uniform mixture for all by one fuel spraying mechanical device to feed all chambers.

11. The engine as in claims 1, further, is using a specific principle of distributing oil services from central supply canal inside its straight crank via metal pads by utilizing the Centrifugal concept on engine rotation, for discharging oil outwardly to engine case.

12. The engine as in claims 1, further, is using independent device for oil service in each pistons by having a private pump for each piston working relatively to the piston's displacement, supplying the required oil quantity for each piston.

13. The engine as in claims 1, further, having the ability of providing auto-output performances, by ability of controlling any piston performance, any piston could work or stops as required during engine rotation.

14. The engine as in claims 1, further, is using a specific design of the free flexible elastic push-arm for pistons, with chambers placed in the wheel outwardly circumference, employing a circular shape.

15. The engine as in claims 1, further comprising, is using valves for chambers, controlled separately without using the essential articulated timing connection, e.g. a cam-shaft.

16. The engine as in claims 1, further comprising; having a discipline seated to provide facile ways in regulating and adjusting all engine activities.

17. The engine as in claims 1, further comprising, using different power wheel numbers or diameters.

18. The engine as in claims 1, further comprising, being positioned vertically as its crank in vertical direction.

19. The engine as in claims 1, further comprising; having a plurality of ignition spark plugs in big diameters wheels

20. The engine as in claims 1, further comprising; changing the feeding accessories or pistons push-arm for using a different type of fuel.
